(19) United States
(12) Patent Application Publication
(10) Pub. No.: US 2023/0263689 A1
(43) Pub. Date: Aug. 24, 2023

(54) WEARABLE DEVICE AND OPERATING METHOD THEREFOR

(71) Applicant: SAMSUNG ELECTRONICS CO., LTD., Suwon-si (KR)

(72) Inventors: Seungyong HYUNG, Suwon-si (KR); Youngbo SHIM, Suwon-si (KR); Kyung-rock KIM, Suwon-si (KR); Jungmi PARK, Suwon-si (KR); Keehong SEO, Suwon-si (KR); Younbaek LEE, Suwon-si (KR); Jinhee CHOI, Suwon-si (KR)

(73) Assignee: SAMSUNG ELECTRONICS CO., LTD., Suwon-si (KR)

(21) Appl. No.: 18/078,287

(22) Filed: Dec. 9, 2022

Related U.S. Application Data
(63) Continuation of application No. PCT/KR2021/001528, filed on Feb. 5, 2021.

(30) Foreign Application Priority Data
Jun. 10, 2020 (KR) 10-2020-0070166
Oct. 8, 2020 (KR) 10-2020-0129870

(51) Int. Cl. A61H 3/00; A61H 1/02

(52) U.S. Cl. CPC A61H 3/00; A61H 1/0244; A61H 2201/165; A61H 2201/1207; A61H 2201/5012; A61H 2201/5084; A61H 2230/625

(57) ABSTRACT

A wearable device capable of outputting a torque on a user is provided. The wearable device includes a motor, a motor driver circuit, a communication circuit for receiving movement information about a first user from a server or an electronic device, a frame connected to the motor, and worn on a body part of a second user so as to support the lower body, a sensor, and a processor for controlling the motor driver circuit so that motion information about the second user is obtained using the sensor, the difference between the obtained motion information and the received motion information is calculated, torque strength is determined based on the calculated difference, and a torque of a determined torque strength is output by the motor.

### CROSS-REFERENCE TO RELATED APPLICATIONS

This application is a Bypass Continuation Application of International Application No. PCT/KR2021/001528 designating the United States, filed on Feb. 5, 2021, in the Korean Intellectual Property Receiving Office and claiming priority to Korean Patent Application No. 10-2020-0070166, filed on Jun. 10, 2020, and priority to Korean Patent Application No. 10-2020-0129870, filed Oct. 8, 2020, in the Korean Intellectual Property Office, the disclosures of which are incorporated by reference herein in their entireties.

### BACKGROUND

### 1. Field

The disclosure relates to a wearable device, and in particular, a wearable device worn on a body of a user to output a torque to the user and a method of operating the wearable device.

### 2. Description of Related Art

In general, a walking assistance device refers to a device or an instrument that helps patients who cannot walk on their own due to various diseases or accidents. For example, a walking assistance device may be used to perform a walking exercise for rehabilitation treatment. Recently, interest in walking assistance devices is increasing as more people are having difficulty walking normally or are having walking discomfort due to leg joint problems. The walking assistance device is mounted on the user’s body to assist the user with muscle strength needed to walk, and induces the user to walk so that the user can walk in a normal walking pattern.

### SUMMARY

According to an aspect of the disclosure, there is provided a wearable device including: a motor; a motor driver circuit configured to control the motor; a communication circuit configured to receive first movement information of a first user from a server or an electronic device; a frame connected to the motor and worn on a body part of a second user; a sensor; and a processor configured to: acquire second movement information of the second user using the sensor, calculate a difference between the second movement information and the first movement information, determine a torque intensity based on the difference, and control the motor driver circuit to output a torque corresponding to the torque intensity through the motor.

Based on the difference being greater than a reference value, the processor may be further configured to: identify a gain for increasing the torque intensity, determine the torque intensity based on the gain and the difference, determine a torque direction to be a first direction opposite to a second direction in which the body part of the second user moves, control a converter to draw power corresponding to the torque intensity from a battery, and turn on one or more switches, among a plurality of switches of the motor driver circuit and turn off remaining switches, among a plurality of switches, to control the motor to rotate in the torque direction to output the torque that resists a movement of the second user.

Based on the difference being less than a reference value, the processor may be further configured to: identify a gain for increasing the torque intensity, determine the torque intensity using the gain and the difference, determine a torque direction to be a same direction as a direction in which the body part of the second user moves, control a converter to draw power corresponding to the torque intensity from a battery, and turn on one or more switches, among a plurality of switches of the motor driver circuit and turn off remaining switches, among a plurality of switches, to control the motor to rotate in the torque direction to output the torque that assists a movement of the second user.

The first movement information may include a joint angle of the first user, wherein the second movement information may include a joint angle of the second user, and wherein the first movement information of the first user may be generated by sensing a movement of the first user in another wearable device worn by the first user located remotely.

The communication circuit may be configured to receive the first movement information, which is extracted from a content including image data and audio data generated by capturing a movement of the first user in advance and movement information generated by sensing a movement of the first user in another wearable device worn by the first user.

The communication circuit may be configured to transmit the second movement information of the second user to the electronic device.

The wearable device may further include: an inertial measurement unit (IMU) sensor configured to acquire at least one of acceleration information, angular velocity information, or posture information of the second user, wherein the communication circuit is configured to transmit the at least one of the acceleration information, the angular velocity information, or the posture information to the electronic device.

According to another aspect of the disclosure, there is provided a remote training system including: a server; a first wearable device configured to be worn on a first user; and a second wearable device configured to be worn on a second user, wherein the first wearable device is further configured to: acquire first movement information of the first user, and transmit the first movement information of the first user to the second wearable device through the server, and wherein the second wearable device is further configured to: receive the first movement information of the first user through the server, acquire second movement information of the second user, calculate a difference between the first movement information of the first user and the second movement information of the second user, determine a torque intensity based on the difference, and output a torque corresponding to the torque intensity to the second user.

Based on the difference being greater than a reference value, the second wearable device may be further configured to: identify a gain for increasing the torque intensity, determine the torque intensity based on the gain and the difference, determine a torque direction to be a first direction opposite to a second direction in which the second user moves, control a converter to draw power corresponding to the torque intensity from a battery, and turn on one or more switches, among a plurality of switches of a motor driver circuit of the second wearable device and turn off remaining switches, among a plurality of switches, to control a motor of the second wearable device to rotate in the torque direction to output the torque that resists a movement of the second user.

Based on the difference being less than a reference value, the second wearable device may be further configured to: identify a gain for increasing the torque intensity, determine the torque intensity using the gain and the difference, determine a torque direction to be a same direction as a direction in which the second user moves, control a converter to draw power corresponding to the torque intensity from a battery, and turn on one or more switches, among a plurality of switches of a motor driver circuit of the second wearable device and turn off remaining switches, among a plurality of switches, to control a motor of the second wearable device to rotate in the torque direction to output the torque that assists a movement of the second user.

The first movement information of the first user may include a joint angle of the first user, wherein the second movement information of the second user may include a joint angle of the second user, and wherein the first wearable device is configured to transmit the second movement information of the second user to the second wearable device through the server.

The second wearable device may be connected to a first electronic device of the first user to receive the first movement information of the first user from the first electronic device of the first user, and wherein the second user wearable device is connected to a second electronic device of the second user.

The first electronic device of the first user may be configured to transmit image data and audio data generated by capturing a movement of the first user to the server and transmit the first movement information of the first user to the server, wherein the server is configured to temporally synchronize the image data, the audio data, and the movement information of the first user received from the first electronic device of the first user and transmit the temporally synchronized image data, audio data, and movement information of the first user to the second electronic device of the second user, and wherein the second electronic device of the second user is configured to output the image data and the audio data received from the server and transmit the first movement information of the first user to the second wearable device.

According to another aspect of the disclosure, there is provided a streaming-based training system including: a server configured to stream content including image data and audio data related to an exercise, and first movement information of a first user to an electronic device of a second user; and a wearable device connected to the electronic device, the wearable device is configured to: receive the first movement information of the first user from the electronic device, acquire second movement information of the second user, calculate a difference between the second movement and the first movement information, determine a torque intensity based on the difference, and output a torque corresponding to the torque intensity to the second user.

According to another aspect of the disclosure, there is provided an operation method of a wearable device, the operation method including: receiving first movement information of a first user from a server or an electronic device; acquiring second movement information of the second user; calculating a difference between the first movement information and the second movement information; determining a torque intensity based on the difference; and controlling a motor of the wearable device to output a torque corresponding to the torque intensity.

### BRIEF DESCRIPTION OF DRAWINGS

FIGS. 1A through 1E are diagrams illustrating a wearable device according to an example embodiment.

FIGS. 2A and 2B are diagrams illustrating examples of motor driver circuits of the wearable device according to an example embodiment.

FIGS. 3A through 3D are diagrams illustrating a torque of a wearable device according to an example embodiment.

FIGS. 4A through 4C are diagrams illustrating a trainee wearable device and a trainer wearable device according to an example embodiment.

FIG. 5 is a diagram illustrating an example of a remote training system according to an example embodiment.

FIGS. 6A, 6B, 7A, 7B, 7C and 7D are diagrams illustrating a screen of a trainee electronic device according to an example embodiment.

FIG. 8 is a diagram illustrating another example of a remote training system according to an example embodiment.

FIGS. 9A and 9B are diagrams illustrating still another example of a remote training system according to an example embodiment.

FIGS. 10A through 10C are diagrams illustrating a streaming-based training system according to an example embodiment.

FIG. 11 is a diagram illustrating exercise analysis and evaluation according to an example embodiment.

FIG. 12 is a flowchart illustrating an operation method of a trainee wearable device according to an example embodiment.

### DETAILED DESCRIPTION

The following structural or functional descriptions are exemplary to merely describe the example embodiments, and the scope of the example embodiments is not limited to the descriptions provided in the present specification. Various changes and modifications can be made thereto by those of ordinary skill in the art.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component, the component can be directly connected or coupled to the other component or intervening components may be present.

As used herein, the singular forms are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching with contextual meanings in the related art and are not to be construed as an ideal or excessively formal meaning unless otherwise defined herein.

Hereinafter, example embodiments will be described in detail with reference to the accompanying drawings. When describing the example embodiments with reference to the accompanying drawings, like reference numerals refer to like components and a repeated description related thereto will be omitted.

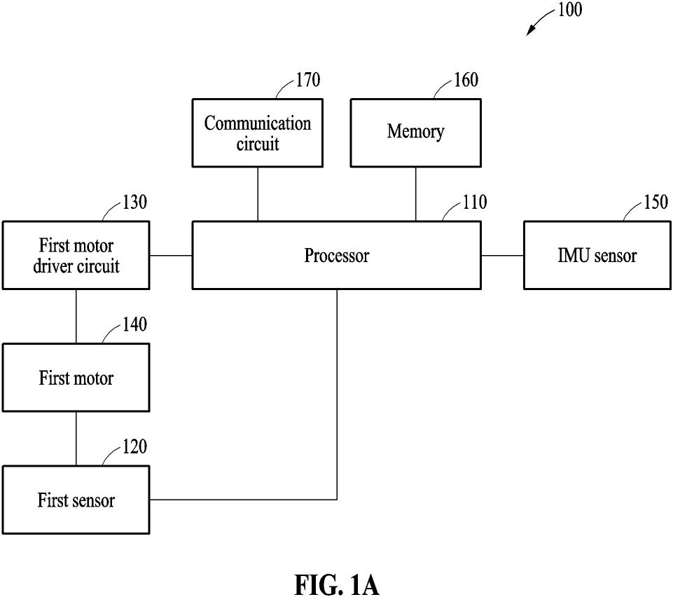

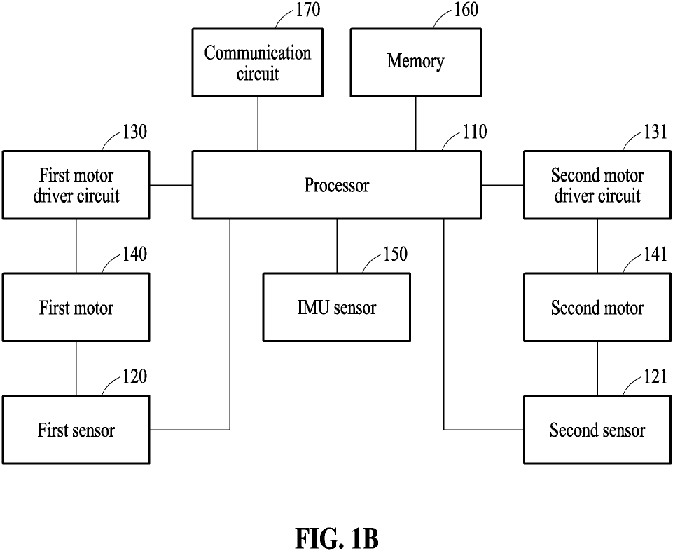

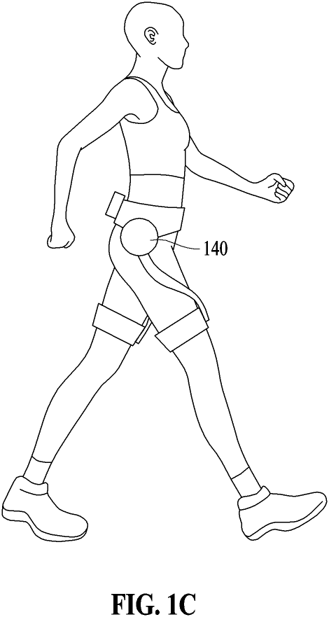

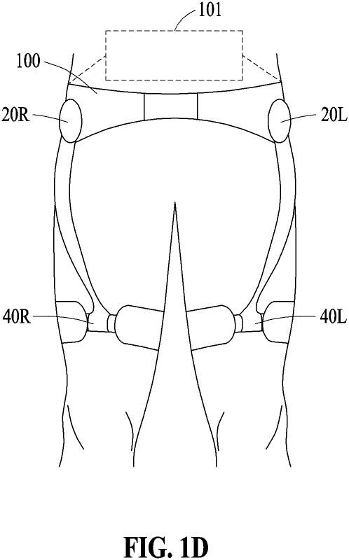

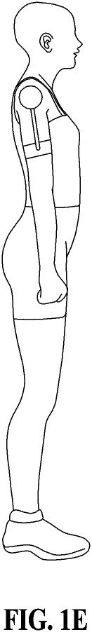

FIGS. 1A through 1E are diagrams illustrating a wearable device according to an example embodiment.

Referring to FIG. 1A, a wearable device 100 may include a processor 110, a first sensor 120, a first motor driver circuit 130, a first motor 140, an inertial measurement unit (IMU) sensor 150, a memory 160, and a communication circuit 170. FIG. 1A illustrates one first sensor 120, one first motor driver circuit 130, and one first motor 140, but it is merely an example. As such, according to another example embodiment, the number of sensors, motor drivers and motors may be different. For example, as illustrated in FIG. 1B, the wearable device 100 may include a first sensor 120 and a second sensor 121, a plurality of motor driver circuits, for example, a first motor driver circuit 130 and a second motor driver circuit 131, and a plurality of motors, for example, a first motor 140 and a second motor 141. In addition, in some cases, the wearable device 100 may include a plurality of processors and/or a plurality of memories. The number of motor driver circuits, the number of motors, or the number of processors may vary according to a body part on which the wearable device 100 is worn.

FIGS. 1C and 1D illustrate examples of the wearable device 100 worn on a hip. Referring to FIG. 1C, the first motor 140 and the second motor 141 may be located adjacent to a right hip joint and a left hip joint of a user, respectively. Accordingly, the wearable device 100, using the first motor 140 and the second motor 141, is capable of providing torque (or force) to flexion and extension of each hip joint when the user walks. Here, flexion may represent forward rotation of the hip joint, and extension may represent posterior rotation of the hip joint. However, the disclosure is not limited to the example illustrated in FIG. 1C. As such, according to another example embodiment, each of the first motor 140 and the second motor 141 may be positioned so as to apply a torque (or force) to adduction and abduction of each hip joint. Here, abduction may indicate a movement away from the body when the user moves laterally, and adduction may indicate a movement closer to the body.

Referring to FIG. 1D, the wearable device 100 includes a frame for fixing the wearable device 100 to the user’s body and supporting the body when the wearable device 100 is worn on the user’s body. The frame may include, for example, a waist wearing frame for fixing the wearable device 100 to the user’s waist and a leg worn frame for fixing a portion of the wearable device 100 to the user’s leg by being worn on the user’s leg. Depending on how the wearable device 100 is implemented, a shape or configuration of the frame may be modified to suit the implementation.

In an example embodiment, the processor 110, the memory 160, the communication circuit 170, and the like for controlling an operation of the wearable device 100 may be located on a back 101 of the user’s waist. The first motor 140 and the first sensor 120 may be located around a right hip joint 20R of a user. The second motor 141 and the second sensor 121 may be located around a left hip joint 20L of the user.

When power for operating the motors is supplied to the first motor 140 located near the right hip joint 20R and the second motor 141 located near the left hip joint 20L, the force output from each of the first motor 140 and the second motor 141 is transmitted to leg worn frames through right transmission portion 40R and left transmission portion 40L, and the force transmitted to the leg worn frame may be applied to a leg of the user.

FIG. 1E illustrates an example of the wearable device 100 worn on an upper body part. The first motor 140 and the second motor 141 may be located around a right shoulder joint and a left shoulder joint, respectively. This is for the wearable device 100 to give torque to the flexion and extension of each shoulder joint. Not limited to the example illustrated in FIG. 1E, the first motor 140 and the second motor 141 may be positioned to give torque to adduction and abduction of the shoulder joints.

Hereinafter, an operation of the wearable device 100 is described in detail based on components of the wearable device 100.

The processor 110 may control an overall operation of the wearable device 100.

The processor 110 may acquire user movement information (for example, a joint angle) using the first sensor 120. For example, the first sensor 120 may include an encoder. Since the first motor 140 and the first sensor 120 are connected to each other, a shaft of the first sensor 120 may rotate corresponding to the first motor. For example, the shaft of the first sensor may rotate as much as the first motor 140 rotates. The first sensor 120 may transmit a bit value corresponding to each rotational position of the shaft to the processor 110. The processor 110 may calculate a rotation angle of the shaft based on the transmitted bit values. For example, when the shaft is in the first rotational position, the first sensor 120 may transmit a first bit value corresponding to the first rotational position to the processor 110. When the shaft is in the second rotational position, the first sensor 120 may transmit a second bit value corresponding to the second rotational position to the processor 110. The processor 110 may calculate a rotation angle of the shaft by subtracting an angle corresponding to the first bit value from an angle corresponding to the second bit value. In some cases, the first sensor 120 may calculate the rotational angle of the shaft by subtracting the second rotational position from the first rotational position of the shaft, and may transmit the calculated rotational angle to the processor 110.

The first sensor 120 is not limited to the encoder described above, and may include a resolver, an acceleration sensor, a gyro sensor, and the like.

Since the description of the first sensor 120 may apply to the description of the second sensor 121, redundant description of the second sensor 121 will be omitted.

Since the joint of the user may be rotated by the torque of the first motor 140, the joint angle of the user may correspond to the rotation angle of the shaft of the first sensor 120. The rotation angle of the shaft of the first sensor 120 in the wearable device 100 may be used as the joint angle of the user. Hereinafter, for convenience of description, the rotation angle of the shaft of the first sensor 120 may also be referred to as the joint angle of the user.

The processor 110 may calculate an angular velocity of the joint using the joint angle of the user. For example, if the joint angle obtained during a period of time T is X, the processor 110 may calculate X/T as the angular velocity of the joint. In some cases, the first sensor 120 may calculate the angular velocity of the joint using the joint angle of the user and transmit the calculated angular velocity to the processor 110.

The first motor driver circuit 130 controls the operation of the first motor 140 under a control of the processor 110. For example, the first motor driver circuit 130 may form an electrical path such that power is supplied from the battery to the first motor 140 under the control of the processor 110.

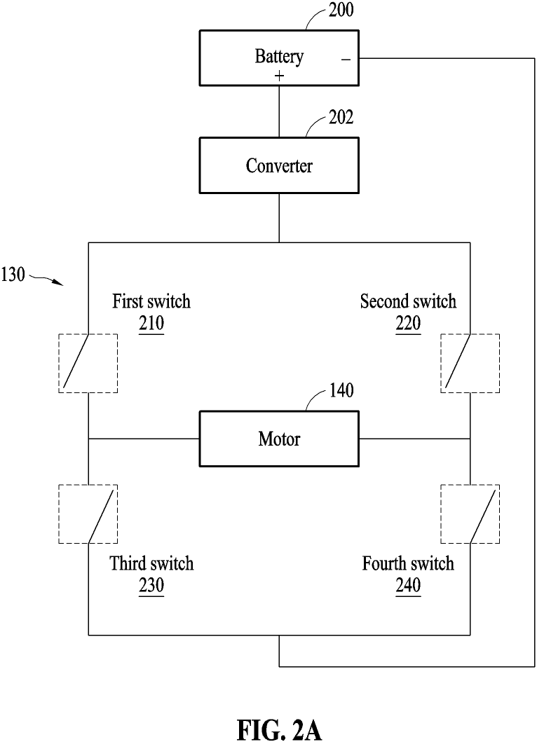

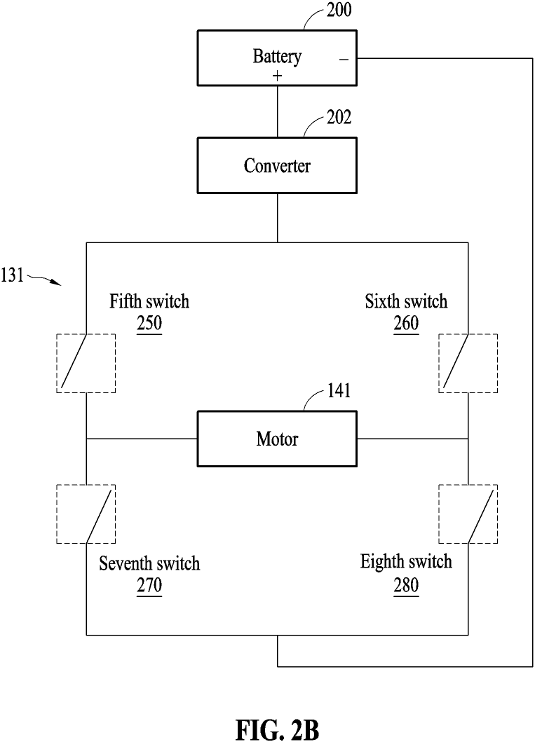

FIGS. 2A and 2B are diagrams illustrating examples of motor driver circuits of the wearable device according example embodiments. For example, FIG. 2A illustrates an example of the first motor driver circuit 130 and FIG. 2B illustrates an example of the second motor driver circuit 131.

The first motor driver circuit 130 illustrated in FIG. 2A is an H-bridge circuit and includes a plurality of switches, for example, a first switch 210, a second switch 220, a third switch 230 and a fourth switch 240. Under the control of the processor 110, the first switch 210 and the fourth switch 240 may be turned on, and the second switch 220 and the third switch 230 may be turned off. A converter 202 may draw power from a battery 200 under the control of the processor 110 and may supply the drawn power to the first motor 140.

When the first switch 210 and the fourth switch 240 are turned on and the second switch 220 and the third switch 230 are turned off, based on the power being supplied, the first motor 140 may rotate in the forward direction. Here, forward rotation may indicate that the first motor 140 rotates in a clockwise direction. According to another example embodiment, the first motor 140 may rotate in a reverse direction. Here, reverse rotation may indicate that the first motor 140 rotates in a counterclockwise direction. For example, under the control of the processor 110, the second switch 220 and the third switch 230 may be turned on, the first switch 220 and the fourth switch 240 may be turned off, the power may be supplied from the battery 200 to the first motor 140 through the converter 202, and the first motor 140 may rotate in the reverse direction.

FIG. 2B illustrates an example of the second motor driver circuit 131. The second motor driver circuit 131 may have a same structure as that of the first motor driver circuit 130. The second motor driver circuit 131 illustrated in FIG. 2B is an H-bridge circuit and may include a plurality of switches, for example, a fifth switch 250, a sixth switch 260, a seventh switch 270 and an eighth switch 280. Under the control of the processor 110, the fifth switch 250 and the eighth switch 280 may be turned on, and the sixth switch 260 and the seventh switch 270 may be turned off. The converter 202 may draw power from the battery 200 under the control of the processor 110 and may supply the drawn power to the second motor 141.

When the fifth switch 250 and the eighth switch 280 are turned on and the sixth switch 260 and the seventh switch 270 are turned off, based on the power being supplied, the second motor 141 may rotate in the forward direction. Under the control of the processor 110, the sixth switch 260 and the seventh switch 270 may be turned on, the fifth switch 250 and the eighth switch 280 may be turned off, and the power may be supplied from the battery 200 to the second motor 141 through the converter 202. At this time, the second motor 141 may rotate in the reverse direction.

Referring back to FIG. 1A, the IMU sensor 150 may measure acceleration and/or angular velocity of a movement of a user. The movement of the user may include an x-axis directional movement, a y-axis directional movement, and a z-axis directional movement. The IMU sensor 150 may measure an acceleration and/or angular velocity for the x-axis directional movement, an acceleration and/or angular velocity for the y-axis directional movement, and an acceleration and/or angular velocity for the z-axis directional movement. The acceleration for each of the x-axis directional movement, the y-axis directional movement, and the z-axis directional movement may be referred to as acceleration information on the movement of the user. The angular velocity for each of the x-axis directional movement, the y-axis directional movement, and the z-axis directional movement may be referred to as angular velocity information on the movement of the user.

When the user moves, the user may rotate in any one of a longitudinal axis, a lateral axis, and a vertical axis, or a combination thereof. Angles at which the user rotates about the longitudinal axis, the horizontal axis, and the vertical axis may be expressed as a roll angle, a pitch angle, and a yaw angle, respectively. The IMU sensor 150 may measure the roll angle, the pitch angle, and the yaw angle. The roll angle, the pitch angle, and the yaw angle of the user may each be referred to as posture information.

The memory 160 may store software used to operate the wearable device 100. In addition, the memory 160 may store the joint angle of the user and the angular velocity of the joint. Also, the memory 160 may store the acceleration information and the angular velocity information associated with the movement of the user, and the posture information on the user.

The memory 160 may include, but is not limited to, a non-volatile memory, a volatile memory, and the like.

The communication circuit 170 may allow the wearable device 100 to communicate with an external device.

The communication circuit 170 may include one or more of a short-range wireless communication circuit, a Wi-Fi communication circuit, and a mobile communication circuit. The short-range wireless communication circuit may communicate with an electronic device located in a short distance according to a short-range wireless communication method (e.g., near field communication (NFC), Bluetooth, Zigbee, etc.). The electronic device may include a mobile device (e.g., a smartphone or tablet PC, etc.) and a display device (e.g., a smart TV). The Wi-Fi communication circuit may communicate with a server by accessing a network according to a Wi-Fi communication method. The mobile communication circuit may communicate with a server by accessing a mobile communication network according to a mobile communication method (e.g., 3G, 4G, 5G, etc.).

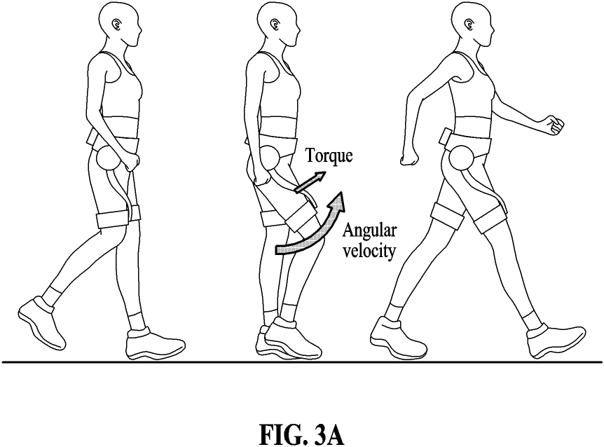

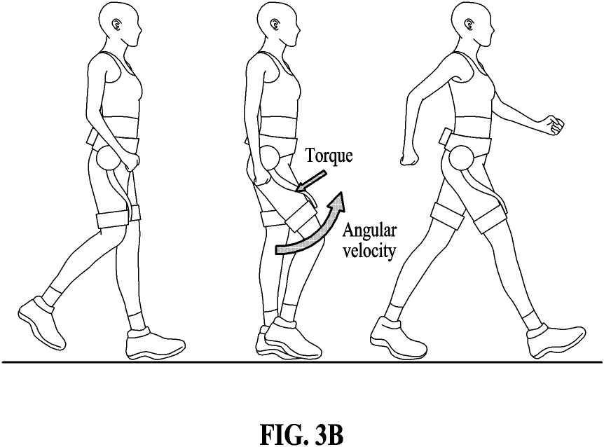

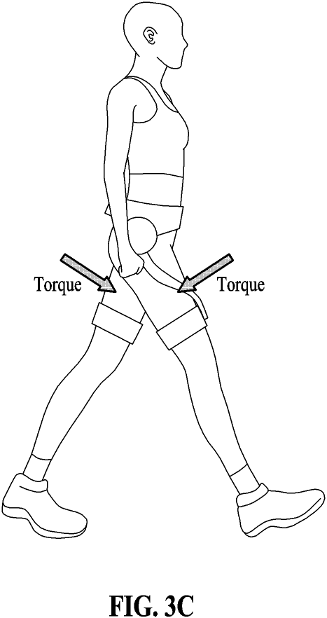

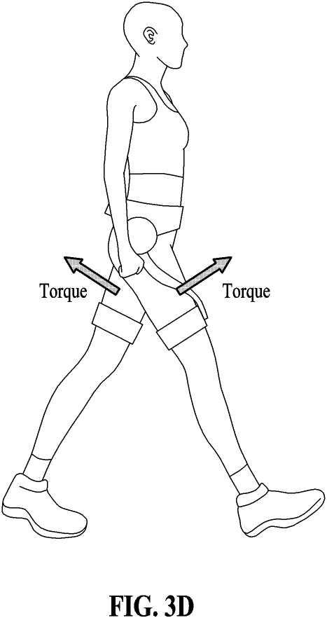

FIGS. 3A through 3D are diagrams illustrating a torque of a wearable device according to an example embodiment.

FIGS. 3A through 3D illustrate examples of the wearable device 100 worn on a hip.

Referring to FIGS. 3A, 1A, and 1B, the wearable device 100 may generate torque in the same direction as the movement of the user. The torque in the same direction as a direction of the movement of the user may be referred to as an “auxiliary torque.”

In the example of FIG. 3A, the processor 110 may calculate or obtain an angular velocity of a right hip joint of a user using the first sensor 120.

The processor 110 may determine control information for torque output using Equation 1 so that the auxiliary torque is provided to the user.

$$\text{Control} \text{information} \text{for} \text{torque} \text{output} \text{=} \text{First} \text{gain} \text{×} \text{Angular} \text{velocity} \qquad \text{[Equation 1]}$$

The control information for torque output may include a torque intensity and a torque direction. The processor 110 may determine the torque intensity and the torque direction using Equation 1.

A first gain and a magnitude of angular velocity are factors that determine the torque intensity. The torque intensity determined only by the magnitude of angular velocity may be an intensity insufficient to assist the movement of the user. Thus, the processor 110 may determine a torque intensity greater than the torque intensity determined only by the magnitude of angular velocity by multiplying the first gain for increasing the torque intensity by the angular velocity as shown in Equation 1. In other words, the processor 110 may multiply the first gain by the angular velocity to determine a torque intensity corresponding to a magnitude greater than the magnitude of angular velocity.

As the first gain and the magnitude of angular velocity are larger, the torque intensity may increase. The first gain may be adjusted by the processor 110 when a user adjustment request is received. In some cases, the first gain may be a fixed value.

The first gain may be, for example, a predetermined value within a range from 0 to 2. The aforementioned range 0 to 2 is only an example, and the range to which the first gain belongs is not limited thereto.

A direction of the angular velocity is a factor that determines the torque direction. The processor 110 may determine the direction of the angular velocity to be the torque direction. According to the example illustrated in FIG. 3A, the right hip joint is rotating counterclockwise, so the direction of the angular velocity is the counterclockwise direction. The processor 110 may determine the torque direction to be the counterclockwise direction.

In some cases, the processor 110 may determine the angular velocity to be the control information for torque output. In such cases, the processor 110 may determine the magnitude of angular velocity to be the torque intensity and determine the direction of the angular velocity to be the torque direction.

The processor 110 may control the converter 202 to draw power from the battery 200, where the drawn power corresponds to the torque intensity determined based on the magnitude of angular velocity. According to another example embodiment, the drawn power may correspond to the torque intensity determined by a product of the first gain and the magnitude of angular velocity. In addition, the processor 110 may turn on the second switch 220 and the third switch 230 of the first motor driver circuit 130 and turn off the first switch 210 and the fourth switch 240 so that the first motor 140 rotates in the same direction as the direction of the angular velocity. The power drawn by the converter 202 may be supplied to the first motor 140 so that the first motor 140 outputs the auxiliary torque to the right leg. Likewise, the second motor 141 may output the auxiliary torque to the left leg.

Referring to FIG. 3B, the wearable device 100 may generate torque in a direction opposite to that of the movement of the user. A torque in the direction opposite to the direction of the movement of the user may be referred to as a “resistance torque”.

In the example of FIG. 3B, the processor 110 may calculate or obtain an angular velocity of the right hip joint of the user using the first sensor 120.

The processor 110 may determine control information for torque output using Equation 2 so that the resistance torque is provided to the user.

$$\text{Control} \text{information} \text{for} \text{torque} \text{output} \text{=} \text{-1×Second} \text{gain} \text{×} \text{Angular} \text{velocity} \qquad \text{[Equation 2]}$$

The control information for torque output may include a torque intensity and a torque direction. The processor 110 may determine the torque intensity and the torque direction using Equation 2.

A second gain and a magnitude of angular velocity may be factors that determine the torque intensity. The torque intensity determined only by the magnitude of angular velocity may be an intensity insufficient to provide resistance to the movement of the user. Thus, the processor 110 may determine a torque intensity greater than the torque intensity determined only by the magnitude of angular velocity by multiplying the second gain for increasing the torque intensity by the angular velocity as shown in Equation 2. In other words, the processor 110 may multiply the second gain by the angular velocity to determine a torque intensity corresponding to a magnitude greater than the magnitude of angular velocity.

As the second gain and the magnitude of angular velocity are larger, the torque intensity may increase. The second gain may be adjusted by the processor 110 when a user adjustment request is received. In some cases, the second gain may be a fixed value.

The second gain may be, for example, a predetermined value within a range from 0 to 2. The aforementioned range 0 to 2 is only an example, and the range to which the second gain belongs is not limited thereto.

In Equation 2, “-1” is a factor that determines the torque direction. The processor 110 may determine the direction opposite to the angular velocity as the torque direction. In the example of FIG. 3B, the right hip joint is rotating in the counterclockwise direction, so the direction of the angular velocity is the counterclockwise direction. Due to “-1”, the processor 110 may determine the torque direction as the clockwise direction, which is a direction opposite to that of the angular velocity.

In some cases, the processor 110 may determine “-1 ×the angular velocity” to be the control information for torque output. In such cases, the processor 110 may determine the magnitude of angular velocity to be the torque intensity and determine the direction opposite to that of the angular velocity to the torque direction.

The processor 110 may control the converter 202 to draw power from the battery 200, where the drawn power corresponds to the torque intensity determined based on the magnitude of angular velocity. According to another example embodiment, the drawn power may correspond to the torque intensity determined by a product of the second gain and the magnitude of angular velocity. In addition, the processor 110 may turn on the first switch 210 and the fourth switch 240 of the first motor driver circuit 130 and turn off the second switch 220 and the third switch 230 so that the first motor 140 rotates in the direction opposite to the direction of the angular velocity. The power drawn by the converter 202 may be supplied to the first motor 140 so that the first motor 140 outputs the resistance torque to the right leg. Likewise, the second motor 141 may output the resistance torque to the left leg.

When an object moves in a fluid, a force that resists the movement of the object is generated. At this time, the force may be proportional to a square of a velocity of the object. In the example of FIG. 3B, the processor 110 may determine the control information for torque output using Equation 3 so that the user feels resistance like walking in a fluid such as water.

$$\text{Control} \text{information} \text{for} \text{torque} \text{output} \text{=} \text{-} \text{1} \text{×} \text{Second} \text{gain} \text{×} {\left(\text{Angular} \text{velocity}\right)}^{\text{2}} \qquad \text{[Equation 3]}$$

According to Equation 3, the processor 110 may determine a product of the second gain and the square of the angular velocity to be the torque intensity and determine the direction opposite to that of the angular velocity to be the torque direction.

The processor 110 may control the converter 202 to draw power corresponding to the torque intensity determined using Equation 3 from the battery 200. In addition, the processor 110 may turn on the first switch 210 and the fourth switch 240 of the first motor driver circuit 130 and turn off the second switch 220 and the third switch 230 so that the first motor 140 rotates in the direction opposite to the direction of the angular velocity. The power drawn by the converter 202 may be supplied to the first motor 140 so that the first motor 140 outputs the resistance torque to the right leg. Likewise, the second motor 141 may output the resistance torque to the left leg.

In the example of FIG. 3C, it is assumed that a hip angle increases as the right hip joint of the user rotates in the counterclockwise direction and the left hip joint rotates in the clockwise direction. Here, as will be described later, the hip angle may correspond to a sum of a right hip-joint angle and a left hip joint angle. In the example of FIG. 3C, the wearable device 100 may provide the user with a torque in a direction opposite to a movement direction in which the hip angle increases. A description of such will be made in detail below.

The processor 110 may acquire the right hip-joint angle of the user using the first sensor 120 and may acquire the left hip-joint angle of the user using the second sensor 121. The processor 110 may calculate the hip angle by adding the right hip-joint angle and the left hip-joint angle.

The processor 110 may calculate a difference between the hip angle and a threshold angle. When the calculated difference is greater than zero, the processor 110 may determine control information for torque output according to Equation 4 so that a torque in a direction opposite to the direction of movement in which the hip angle increases is provided to the user. In other words, when the hip angle is greater than the threshold angle, the processor 110 may determine the control information for torque output using Equation 4.

$$\begin{matrix}\text{Control} \text{information} \text{for} \text{torque} \text{output} \text{=} \text{-} \text{1} \text{×} \text{Third} \text{} \text{gain} \text{×} \\ \left(\text{Hip} \text{angle} \text{-} \text{Threshold} \text{angle}\right)\end{matrix} \qquad \text{[Equation 4]}$$

In Equation 4, a third gain and a value of “the hip angle - the threshold angle” may be factors that determine the torque intensity. The torque intensity determined only by the value of “the hip angle - the threshold angle” may be an intensity insufficient to provide resistance to the movement in the direction in which the hip angle increases. Thus, the processor 110 may determine a torque intensity greater than the torque intensity determined only by the value of “the hip angle – the threshold angle” by multiplying the third gain for increasing the torque intensity by “the hip angle – the threshold angle” as shown in Equation 4. In other words, the processor 110 may multiply the third gain by “the hip angle – the threshold angle” to determine a torque intensity corresponding to a value greater than the value of “the hip angle – the threshold angle.”

As the third gain and the value of “the hip angle - the threshold angle” increase, the torque intensity may increase. The third gain may be adjusted by the processor 110 when a user adjustment request is received. In some cases, the third gain may be a fixed value.

The third gain may be, for example, a predetermined value within a range from 0 to 6. The aforementioned range 0 to 6 is only an example, and the range to which the third gain belongs is not limited thereto.

In Equation 4, “-1” is a factor that determines the torque direction. The processor 110 may determine the direction opposite to the direction in which the hip angle increases to be the torque direction. In the example of FIG. 3C, the right hip joint rotates in the counterclockwise direction and the left hip-joint angle may rotate in the clockwise direction, so the processor 110 may determine the clockwise direction as a direction of a torque to be output to the right leg and determine the counterclockwise direction as a direction of a torque to be output to the left leg.

According to another example embodiment, the processor 110 may determine the control information for torque output using Equation 4-1, which is different than Equation 4.

$$\begin{matrix}\text{Control} \text{information} \text{for} \text{torque} \text{output} \text{=} \text{-} \text{1} \text{×} \\ \left(\text{the} \text{hip} \text{angle} \text{-} \text{the} \text{threshold} \text{angle}\right)\end{matrix} \qquad \text{[Equation 4-1]}$$

“In this case, the processor 110 may determine the value of “the hip angle – the threshold angle” to be the torque intensity and determine the direction opposite to the direction in which the hip angle increases to be the torque direction.

As According to another example embodiment, the processor 110 may determine control information for torque output using Equation 5 so that a torque in a direction opposite to the direction of the movement in which the hip angle increases is provided to the user.

$$\text{Control} \text{information} \text{for} \text{torque} \text{output=-1} \times \text{Third} \text{gain} \times \text{Hip} \text{angle} \qquad \text{[Equation 5]}$$

According to Equation 5, the processor 110 may determine a product of a value of the hip angle and the third gain to be the torque intensity, and determine the direction opposite to the direction in which the hip angle increases to be the torque direction.

According to another example embodiment, the processor 110 may determine the control information for torque output using Equation 5-1, which is different that Equation 6.

$$\text{Control} \text{information} \text{for} \text{torque} \text{output=-1} \times \text{the} \text{hip} \text{angle} \qquad \text{[Equation 5-1]}$$

In this case, the processor 110 may determine the value of the hip angle to be the torque intensity and determine the direction opposite to the direction in which the hip angle increases to be the torque direction.

The processor 110 may control the converter 202 to draw the power corresponding to the torque intensity determined according to Equation 4, Equation 4-1, Equation 5, or Equation 5-1 from the battery 200. In addition, the processor 110 may provide a control signal to each of the first motor driver circuit 130 and the second motor driver circuit 131 to rotate the first motor 140 and the second motor 141 in the direction opposite to the direction in which the hip angle increases. For example, the processor 110 may turn on the first switch 210 and the fourth switch 240 of the first motor driver circuit 130 and turn off the second switch 220 and the third switch 230 so that the first motor 140 rotates in the clockwise direction. The processor 110 may turn on the sixth switch 260 and the seventh switch 270 of the second motor driver circuit 131 and turn off the fifth switch 250 and the eighth switch 280 so that the second motor 141 rotates in the counterclockwise direction. The power drawn by the converter 202 may be supplied to the first motor 140 and the second motor 141 so that the first motor 140 and the second motor 141 provide the user with the resistance torque for the movement in which the hip angle increases.

In an example embodiment, the wearable device 100 may provide the user with a torque in a direction opposite to a direction of movement in which one hip joint angle of the user increases. In the example of FIG. 3C, it is assumed that a first hip joint of the user rotates in the counterclockwise direction and a second hip joint does not rotate.

The processor 110 may obtain the first hip-joint angle of the user using the first sensor 120.

The processor 110 may calculate a difference between the first hip-joint angle and the threshold angle. When the calculated difference is greater than zero, the processor 110 may determine control information for torque output using Equation 6 so that a torque in a direction opposite to a direction of movement in which a hip joint angle of the user increases is provided to the user. In other words, when the first hip-joint angle is greater than the threshold angle, the processor 110 may determine the control information for torque output using Equation 6.

$$\begin{matrix}\text{Control} \text{information} \text{for} \text{torque} \text{output} = \\ - 1 \times \text{Third} \text{gain} \times \left(\text{First} \text{hip-joint} \text{angle} \text{-} \text{Threshold} \text{angle}\right)\end{matrix} \qquad \text{[Equation 6]}$$

According to Equation 6, the processor 110 may determine a product of the value of “the first hip-joint angle – the threshold angle” and the third gain to be the torque intensity, and determine a direction opposite to a rotation direction of the first hip joint to be the torque direction.

According to another example embodiment, the processor 110 may determine the control information for torque output using Equation 6-1, which is different than Equation 6.

$$\begin{matrix}\text{Control} \text{information} \text{for} \text{torque} \text{output} = \\ - 1 \times \left(\text{the} \text{first} \text{hip-joint} \text{angle-the} \text{threshold} \text{angle}\right)\end{matrix} \qquad \text{[Equation 6-1]}$$

In this case, the processor 110 may determine the value of “the first hip-joint angle - the threshold angle” to be the torque intensity, and determine the direction opposite to the rotation direction of the first hip joint to be the torque direction.

According to another example embodiment, the processor 110 may determine the control information for torque output using Equation 7 so that a torque in the direction opposite to the direction of movement in which the hip joint angle of the user increases is provided to the user.

$$\begin{matrix}\text{Control} \text{information} \text{for} \text{torque} \text{output} = - 1 \times \text{third} \text{gain} \times \\ \text{First} \text{hip} - \text{joint} \text{angle}\end{matrix} \qquad \text{[Equation 7]}$$

According to Equation 7, the processor 110 may determine a product of a value of the first hip-joint angle and the third gain to be the torque intensity, and determine the direction opposite to the rotation direction of the first hip joint to be the torque direction.

According to another example embodiment, the processor 110 may determine “-1 × the first hip-joint angle” to be the control information for torque output using Equation 7-1, which is different than Equation 7.

$$\begin{matrix}\text{Control information for torque output = -1} \times \\ \text{the first hip-joint angle}\end{matrix} \qquad \text{[Equation 7-1]}$$

In this case, the processor 110 may determine the value of the first hip-joint angle to be the torque intensity, and determine the direction opposite to the rotation direction of the first hip joint to be the torque direction.

The processor 110 may control the converter 202 to draw the power corresponding to the torque intensity determined according to Equation 6, Equation 6-1, Equation 7, or Equation 7-1 from the battery 200. In addition, the processor 110 may turn on the first switch 210 and the fourth switch 240 of the first motor driver circuit 130 and turn off the second switch 220 and the third switch 230 so that the first motor 140 rotates in a direction opposite to the rotation direction of the first hip joint. The power drawn by the converter 202 may be supplied to the first motor 140 so that the first motor 140 provides the user with the resistance torque for the movement in which the first hip-joint angle increases.

In the example of FIG. 3D, it is assumed that a hip angle increases as the right hip joint of the user rotates in the counterclockwise direction and the left hip joint rotates in the clockwise direction. In the example of FIG. 3D, the wearable device 100 may provide the user with a torque in a same direction as a movement direction in which the hip angle increases. A description of such will be made in detail below.

In the example of FIG. 3D, the processor 110 may acquire the right hip-joint angle of the user using the first sensor 120 and may acquire the left hip-joint angle of the user using the second sensor 121. The processor 110 may calculate the hip angle by adding the right hip-joint angle and the left hip-joint angle.

The processor 110 may calculate a difference between the hip angle and a threshold angle. When the calculated difference is greater than zero, the processor 110 may determine control information for torque output according to Equation 8 so that the torque in the same direction as the movement direction in which the hip angle increases is provided to the user. In other words, when the hip angle is greater than the threshold angle, the processor 110 may determine the control information for torque output using Equation 8.

$$\begin{matrix}\text{Control information for torque output = Fourth gain} \times \\ \left(\text{Hip angle - Threshold angle}\right)\end{matrix} \qquad \text{[Equation 8]}$$

In Equation 8, a fourth gain and a value of “the hip angle – the threshold angle” may be factors that determine the torque intensity. The torque intensity determined only by the value of “the hip angle – the threshold angle” may be an intensity insufficient to assist the movement in the direction in which the hip angle increases. Thus, the processor 110 may determine a torque intensity greater than the torque intensity determined only by the value of “the hip angle – the threshold angle” by multiplying the fourth gain for increasing the torque intensity by “the hip angle – the threshold angle” as shown in Equation 8. In other words, the processor 110 may multiply the fourth gain by “the hip angle – the threshold angle” to determine a torque intensity corresponding to a value greater than the value of “the hip angle – the threshold angle.”

As the fourth gain and the value of “the hip angle – the threshold angle” increase, the torque intensity may increase. The fourth gain may be adjusted by the processor 110 when a user adjustment request is received. In some cases, the fourth gain may be a fixed value.

The fourth gain may be, for example, a predetermined value within a range from 0 to 6. The aforementioned range 0 to 6 is only an example, and the range to which the fourth gain belongs is not limited thereto.

The processor 110 may determine the direction in which the hip angle increases to be the torque direction. In the example of FIG. 3D, the right hip-joint angle rotates in the counterclockwise direction and the left hip-joint angle may rotate in the clockwise direction, so the processor 110 may determine the counterclockwise direction as a direction of a torque to be output to the right leg and determine the clockwise direction as a direction of a torque to be output to the left leg.

According to another example embodiment, the processor 110 may determine the control information for torque output using Equation 8-1, which is different than Equation 8.

$$\begin{matrix}\text{Control information for torque output = the hip angle -} \\ \text{the threshold angle}\end{matrix} \qquad \text{[Equation 8-1]}$$

In this case, the processor 110 may determine the value of “the hip angle - the threshold angle” to be the torque intensity and determine the direction in which the hip angle increases to be the torque direction.

As another example different from Equation 8, the processor 110 may determine control information for torque output according to Equation 9 so that the torque in the same direction as the movement direction in which the hip angle increases is provided to the user.

$$\text{Control information for torque output = Fourth gain} \times \text{Hip angle} \qquad \text{[Equation 9]}$$

According to Equation 9, the processor 110 may determine a product of a value of the hip angle and the fourth gain to be the torque intensity, and determine the direction in which the hip angle increases to be the torque direction.

According to another example embodiment, the processor 110 may determine the control information for torque output using Equation 9-1, which is different than Equation 9.

$$\text{Control information for torque output = hip angle} \qquad \text{[Equation 9-1]}$$

In this case, the processor 110 may determine the value of the hip angle to be the torque intensity and determine the direction in which the hip angle increases to be the torque direction.

The processor 110 may control the converter 202 to draw the power corresponding to the torque intensity determined according to Equation 8, Equation 8-1, Equation 9, or Equation 9-1 from the battery 200. In addition, the processor 110 may provide a control signal to each of the first motor driver circuit 130 and the second motor driver circuit 131 to rotate the first motor 140 and the second motor 141 in the direction in which the hip angle increases. For example, the processor 110 may turn on the second switch 220 and the third switch 230 of the first motor driver circuit 130 and turn off the first switch 210 and the fourth switch 240 so that the first motor 140 rotates in the same direction as the rotation direction (e.g., the counterclockwise direction) of the right hip joint. The processor 110 may turn on the fifth switch 250 and the eighth switch 280 of the second motor driver circuit 131 and turn off the sixth switch 260 and the seventh switch 270 so that the second motor 141 rotates in the same direction as the rotation direction (e.g., the clockwise direction) of the left hip joint. The power drawn by the converter 202 may be supplied to the first motor 140 and the second motor 141 so that the first motor 140 and the second motor 141 provide the user with the auxiliary torque for the movement in which the hip angle increases.

In an example embodiment, the wearable device 100 may provide the user with a torque in a same direction as a direction of movement in which one hip joint angle of the user increases. In the example of FIG. 3D, it is assumed that a first hip joint of the user rotates in the counterclockwise direction and a second hip joint does not rotate.

The processor 110 may obtain the first hip-joint angle of the user using the first sensor 120. The processor 110 may calculate a difference between the first hip-joint angle and the threshold angle. When the calculated difference is greater than zero, the processor 110 may determine control information for torque output using Equation 10 so that a torque in the same direction as the direction of movement in which one hip joint angle of the user increases. In other words, when the first hip-joint angle is greater than the threshold angle, the processor 110 may determine the control information for torque output using Equation 10.

$$\begin{matrix}\text{Control} \text{information} \text{for} \text{torque} \text{output} \text{=} \\ \text{Fourth} \text{gain} \text{×} \left(\text{First} \text{hip-joint} \text{angle} \text{-} \text{Threshold} \text{angle}\right)\end{matrix} \qquad \text{[Equation 10]}$$

According to Equation 10, the processor 110 may determine a product of the value of “the first hip-joint angle – the threshold angle” and the fourth gain to be the torque intensity, and determine the rotation direction of the first hip joint to be the torque direction.

According to another example embodiment, the processor 110 may determine “the control information for torque output using Equation 10-1, which is different than Equation 10.

$$\text{Control} \text{information} \text{for} \text{torque} \text{output} \text{=} \text{the} \text{first} \text{hip-joint} \text{angle} \text{-} \text{the} \text{threshold} \text{angle} \qquad \text{[Equation 10-1]}$$

In this case, the processor 110 may determine the value of “the first hip-joint angle – the threshold angle” to be the torque intensity, and determine the rotation direction of the first hip joint to be the torque direction.

According to another example embodiment, the processor 110 may determine control information for torque output using Equation 11 so that the torque in the same direction as the direction of movement in which the first hip-joint angle increases is provided to the user.

$$\text{Control} \text{information} \text{for} \text{torque} \text{output} \text{=} \text{Fourth} \text{gain} \text{×} \text{First} \text{hip-joint} \text{angle} \qquad \text{[Equation 11]}$$

According to Equation 11, the processor 110 may determine the torque intensity corresponding to a product of the value of the first hip-joint angle and the fourth gain, and determine the rotation direction of the first hip joint to be the torque direction.

According to another example embodiment, the processor 110 may determine the control information for torque output using Equation 11-1, which is different than Equation 11.

$$\text{Control} \text{information} \text{for} \text{} \text{torque} \text{output} \text{=} \text{the} \text{first} \text{hip-joint} \text{angle} \qquad \text{[Equation 11-1]}$$

In this case, the processor 110 may determine the value of the first hip-joint angle to be the torque intensity and determine the rotation direction of the first hip joint to be the torque direction.

The processor 110 may control the converter 202 to draw the power corresponding to the intensity determined according to Equation 10, Equation 10-1, Equation 11, or Equation 11-1 from the battery 200. In addition, the processor 110 may turn on the second switch 220 and the third switch 230 of the first motor driver circuit 130 and turn off the first switch 210 and the fourth switch 240 so that the first motor 140 rotates in the same direction as the rotation direction of the first hip joint. The power drawn by the converter 202 may be supplied to the first motor 140 so that the first motor 140 provides the user with the auxiliary torque for the movement in which the first hip-joint angle increases.

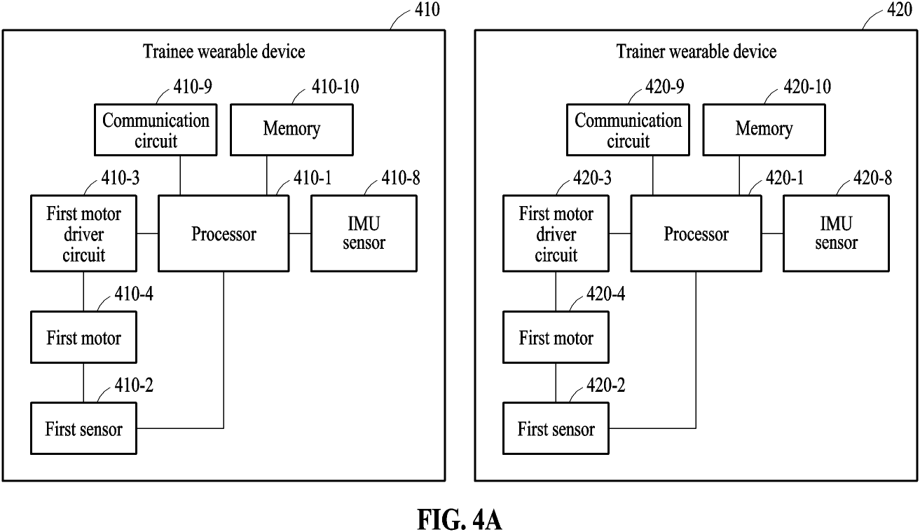

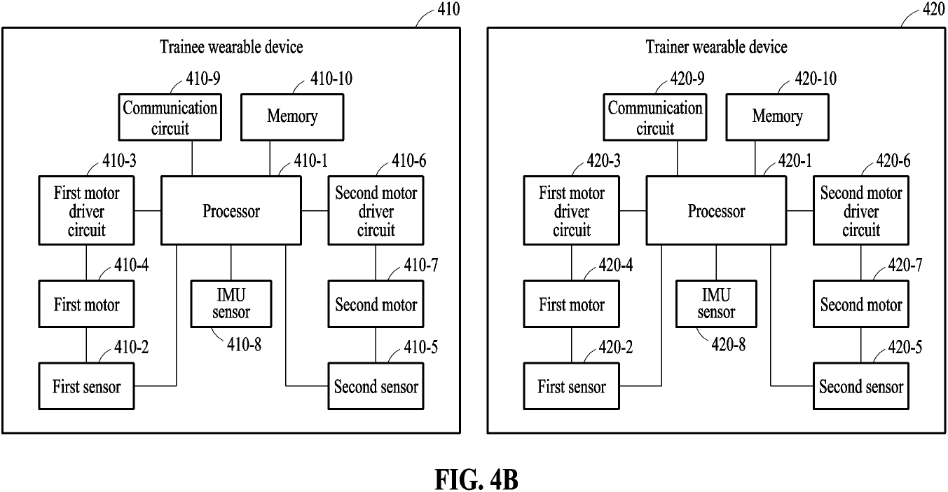

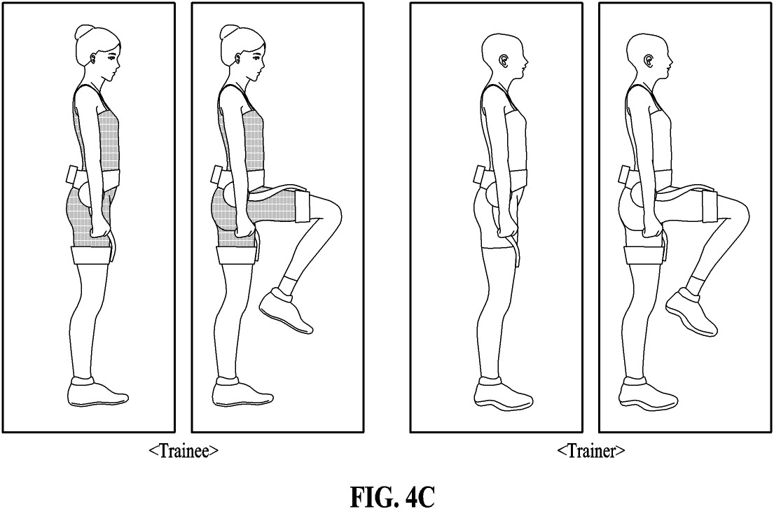

FIGS. 4A through 4C are diagrams illustrating a trainee wearable device and a trainer wearable device according to an example embodiment.

FIG. 4A illustrates a trainee wearable device 410 and a trainer wearable device 420.

The trainee wearable device 410 refers to a wearable device worn by a trainee, and the trainer wearable device 420 refers to a wearable device worn by a trainer. The trainer may also be referred to as a first user, and the trainee may also be referred to as a second user. The trainer wearable device 420 may also be referred to as a first wearable device, and the trainee wearable device 410 may also be referred to as a second wearable device.

The trainee wearable device 410 may include a processor 410-1, a first sensor 410-2, a first motor driver circuit 410-3, a first motor 410-4, an IMU sensor 410-8, a communication circuit 410-9, and a memory 410-10. However, the disclosure is not limited thereto, and as such according to another example embodiment illustrated in FIG. 4B, the trainee wearable device 410 may include first and second sensors 410-2 and 410-5, a plurality of motor driver circuits, for example, first and second motor driver circuits 410-3 and 410-6, and a plurality of motors, for example, first and second motors 410-4 and 410-7.

The trainer wearable device 420 may include a processor 420-1, a first sensor 420-2, a first motor driver circuit 420-3, a first motor 420-4, an IMU sensor 420-8, a communication circuit 420-9, and a memory 420-10. Not limited thereto, as illustrated in the example of FIG. 4B, the trainer wearable device 420 may include first and second sensors 420-2 and 420-5, a plurality of motor driver circuits, for example, first and second motor driver circuits 420-3 and 420-6, and a plurality of motors, for example, first and second motors 420-4 and 420-7.

Operations of components in the trainer wearable device 410 and operations of components in the trainer wearable device 420 may be the same as the operations of the components in the wearable device 100 described with reference to FIGS. 1A through 3D.

As in the example illustrated in FIG. 4C, the trainer wearing the trainer wearable device 420 and the trainee wearing the trainee wearable device 410 may raise and lower knees of first legs. Although the trainer and the trainee are located in different spaces, the trainee may learn the trainer’s movement exactly as the trainer intended according to the trainer’s movement (physical force) transmitted through the trainee wearable device 410. For example, if the trainee is slower than the trainer’s movement or the posture is wrong, a physical force based on a difference between a movement speed of the trainer and a movement speed of the trainee (or a difference between a trainer’s posture and a trainee’s posture) may be transmitted to the trainee through the trainee wearable device 410. In this example, the trainee may correct the posture and movement through the force transmitted through the trainee wearable device 410. The trainee may need to exercise in the trainer’s posture to achieve the exercise effect intended by the trainer. Thus, through the trainee wearable device 410 that feeds back the trainer’s movement, the trainee may obtain a maximized exercise effect than following the trainer’s movement using only visual information. A description of such will be made in detail below.

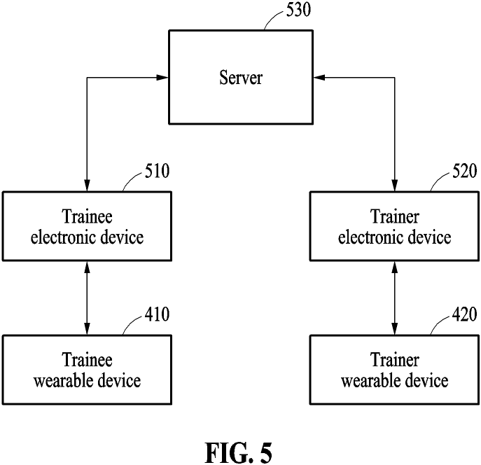

FIG. 5 is a diagram illustrating an example of a remote training system according to an example embodiment.

Referring to FIG. 5, a remote training system includes the trainee wearable device 410, the trainer wearable device 420, a server 530, a trainee electronic device 510, and a trainer electronic device 520. However, the disclosure is not limited thereto, and as such, the remote training system may include a separate trainee electronic device 510 and/or a trainer electronic device 520.

The trainee electronic device 510 refers to an electronic device of a trainee. The trainee electronic device 510 may include a mobile device (e.g., a smartphone, a tablet terminal, etc.) and/or a display device (e.g., a smart TV) of the trainee.

The trainer electronic device 520 refers to an electronic device of a trainer. The trainer electronic device 520 may include a mobile device (e.g., a smartphone, a tablet terminal, etc.) and/or a display device (e.g., a smart TV) of the trainer.

The communication circuit 410-9 of the trainee wearable device 410 may be connected to a short-range wireless communication circuit of the trainee electronic device 510 through a short-range wireless communication link (e.g., Bluetooth). Likewise, the communication circuit 420-9 of the trainer wearable device 420 may be connected to a short-range wireless communication circuit of the trainer electronic device 520 through a short-range wireless communication link (e.g., Bluetooth).

The trainee electronic device 510 may include a Wi-Fi communication circuit and/or a mobile communication circuit, and may communicate with the server 530 through the Wi-Fi communication circuit or the mobile communication circuit. Likewise, the trainer electronic device 520 may include a Wi-Fi communication circuit and/or a mobile communication circuit, and may communicate with the server 530 through the Wi-Fi communication circuit or the mobile communication circuit.

As described with reference to FIG. 4C, it is assumed that a trainer and a trainee raise and lower the knees of the first legs. When the trainer and the trainee raise the knees of the first legs upward, the hip joint of the first leg (e.g., the first hip joint) of each of the trainer and the trainee may rotate in the counterclockwise direction.

The trainer electronic device 520 may generate audio data and image data for the trainer’s exercise by recording the trainer’s exercise.

The processor 420-1 of the trainer wearable device 420 may acquire a first hip-joint angle X_1 of the trainer using the first sensor 420-2 and transmit the first hip-joint angle X_1 of the trainer to the trainer electronic device 520 using the communication circuit 420-9.

The IMU sensor 420-8 of the trainer wearable device 420 may measure acceleration information, angular velocity information, and posture information on the movement of the trainer. As described above, the acceleration information may include acceleration of the movement of the trainer in each of the x-axial direction, the y-axial direction, and the z-axial direction. The angular velocity information may include an angular velocity of the movement of the trainer in each of the x-axial direction, the y-axial direction, and the z-axial direction. The posture information may include a roll angle, a pitch angle, and a yaw angle of the trainer. The processor 420-1 of the trainer wearable device 420 may transmit the acceleration information, the angular velocity information, and the posture information on the movement of the trainer to the trainer electronic device 520 using the communication circuit 420-9.

The trainer electronic device 520 may transmit the audio data, the image data, and the first hip-joint angle X_1 of the trainer to the server 530. In addition, the trainer electronic device 520 may transmit the acceleration information, the angular velocity information, and the posture information on the movement of the trainer to the server 530.

In order to prevent a discrepancy between audio/video data and hip angle data which may be caused by a difference in data sampling time between the trainer electronic device 520 and the trainer wearable device 420, the server 530 may perform time synchronization on the audio data, the image data, and the first hip-joint angle X_1 of the trainer. Since the audio data and the image data are generated by the trainer electronic device 520 and the first hip-joint angle X_1 is generated by the trainer wearable device 420, an entity that generates the audio data and the image data is different from an entity that generates the first hip-joint angle X_1. Accordingly, the server 530 may temporally synchronize a trainer’s voice, a trainer’s movement shown in an image, and the first hip-joint angle X_1. For example, the audio data and the image data may have time values ta, tb, tc, etc. In this example, among the time values ta, tb, tc, etc. of the audio data and the image data, ta may be the earliest. In addition, the first hip-joint angle X_1 may have time values ta, tb, tc, etc. The server 530 may synchronize the audio data, the image data, and the first hip-joint angle X_1 based on ta.

The server 530 may transmit the temporally synchronized audio data, image data, and first hip-joint angle X_1 to the trainee electronic device 510.

The trainee electronic device 510 may display the image data received from the server 530 on a display and output the audio data through a speaker. Through this, the trainee may visually see the trainer exercising and hear the trainer’s voice through the trainee electronic device 510.

In addition, the trainee electronic device 510 may transmit the first hip-joint angle X_1 of the trainer received from the server 530 to the trainee wearable device 410. In other words, the communication circuit 410-9 of the trainee wearable device 410 may receive the first hip-joint angle X_1 of the trainer from the trainee electronic device 510.

The processor 410-1 of the trainee wearable device 410 may set the first hip-joint angle X_1 of the trainer to be a threshold angle. In other words, the processor 410-1 of the trainee wearable device 410 may set the first hip-joint angle X_1 of the trainer as an exercise posture of the trainer.

The processor 410-1 of the trainee wearable device 410 may acquire a first hip-joint angle Y_1 of the trainee using the first sensor 410-2.

The processor 410-1 of the trainee wearable device 410 may calculate a difference “Y_1 - X_1” between the first hip-joint angle Y_1 of the trainee and the threshold angle X_1.

When “Y_1 - X_1” calculated by the processor 410-1 of the trainee wearable device 410 is greater than zero, an angle at which the trainee raises the knee of the first leg may be greater than the threshold angle. In this case, the processor 410-1 may guide the trainee to lower the knee of the first leg by controlling the resistance torque to be applied to the first leg. For example, like the first motor driver circuit 130 of FIG. 2A, the first motor driver circuit 410-3 of the trainee wearable device 410 may include the first switch 210 through the fourth switch 240. The processor 410-1 may determine the torque intensity by multiplying a value of “Y_1 - X_1” by a gain (for example, the third gain described with reference to FIG. 3C). In some cases, the processor 410-1 may determine the torque intensity using a table in which the value of “Y_1 - X_1” and the torque intensity are mapped. Table 1 shows an example of a table in which the value of “Y_1 - X_1” and the torque intensity are mapped.

TABLE 1

| | |
|---|---|
| Value of “Y 1—X 1” | Torque intensity |
| a1 | b1 |
| a2 | b2 |
| a3 | b3 |
| ... | ... |

“Y_1 — X_1” may need to be greater than zero to provide the resistance torque to the first leg of the trainee. Thus, the processor 410-1 may determine a direction opposite to the rotation direction of the first hip joint of the trainee to be the torque direction.

The processor 410-1 may control the converter 202 to draw power corresponding to the determined torque intensity from the battery 200. Since the first hip joint of the trainee rotates in the counterclockwise direction, the processor 410-1 may turn on the first switch 210 and the fourth switch 240 of the first motor driver circuit 410-3 and turn off the second switch 220 and the third switch 230 so that the first motor 410-4 rotates in the clockwise direction.

The power drawn by the converter 202 may be supplied to the first motor 410-4. At this time, the first motor 410-4 may provide the resistance torque to the first leg, and the trainee may lower the knee of the first leg according to the received resistance torque without raising the knee of the first leg higher. Through this, the processor 410-1 may guide the exercise posture of the trainee to be close to the exercise posture of the trainer.

When “Y_1 - X_1” calculated by the processor 410-1 of the trainee wearable device 410 is less than zero, the angle at which the trainee raises the knee of the first leg may be smaller than the threshold angle. In this case, the trainee wearable device 410 may not provide a torque to the user. As another example, when “Y_1 - X_1” is less than zero, the processor 410-1 may guide the trainee to further lift the knee of the first leg upward by controlling the auxiliary torque to be applied to the first leg. For example, the processor 410-1 may determine the torque intensity by multiplying the value of “Y_1 - X_1” and the gain. In this example, the gain may be, for example, the third gain described with reference to FIG. 3C or the fourth gain described with reference to FIG. 4C but is not limited thereto. In some cases, the processor 410-1 may determine the torque intensity using Table 1 or determine the torque intensity using Table 2 different from Table 1.

TABLE 2

| | |
|---|---|
| Value of “Y_1-X_1” | Torque intensity |
| a1 | c1 |
| a2 | c2 |
| a3 | c3 |
| ... | ... |

“Y_1 - X_1” may need to be less than zero to provide the auxiliary torque to the first leg of the trainee. Thus, the processor 410-1 may determine the rotation direction of the first hip joint of the trainee to be the torque direction.

The processor 410-1 may control the converter 202 to draw power corresponding to the determined torque intensity from the battery 200. Since the first hip joint of the trainee rotates in the counterclockwise direction, the processor 410-1 may turn on the second switch 220 and the third switch 230 of the first motor driver circuit 410-3 and turn off the first switch 210 and the fourth switch 240 so that the first motor 410-4 rotates in the counterclockwise direction.

The power drawn by the converter 202 may be supplied to the first motor 410-4. At this time, the first motor 410-4 may provide the auxiliary torque to the first leg, and the trainee may raise the knee of the first leg higher with the aid of the auxiliary torque provided. Through this, the processor 410-1 may guide the exercise posture of the trainee to be close to the exercise posture of the trainer.

The IMU sensor 410-8 of the trainee wearable device 410 may measure acceleration information, angular velocity information, and posture information on the movement of the trainee. As described above, the acceleration information may include acceleration of the movement of the trainee in each of the x-axial direction, the y-axial direction, and the z-axial direction, the angular velocity information may include an angular velocity of the movement of the trainee in each of the x-axial direction, the y-axial direction, and the z-axial direction, and the posture information may include a roll angle, a pitch angle, and a yaw angle of the trainee.

The processor 410-1 may transmit the acceleration information, the angular velocity information, the posture information, and the first hip-joint angle Y_1 of the trainee to the trainee electronic device 510 using the communication circuit 410-9.

The trainee electronic device 510 may transmit the first hip-joint angle Y_1, the acceleration information, the angular velocity information, and the posture information to the server 530. The server 530 may store the acceleration information, the angular velocity information, the posture information, and the first hip-joint angle Y_1 of the trainee.

In an example embodiment, the server 530 may allow the trainer to receive feedback on the trainee’s movement through the trainer wearable device 420. For example, the server 530 may transmit the first hip-joint angle Y_1 of the trainee to the trainer electronic device 520, and the trainer electronic device 520 may transmit the first hip-joint angle Y_1 of the trainee to the trainer wearable device 420.

The processor 420-1 of the trainer wearable device 420 may calculate a difference “Y_1 - X_1” between the first hip-joint angle X_1 of the trainer and the first hip-joint angle Y_1 of the trainee.

When “Y_1 - X_1” calculated by the processor 420-1 of the trainer wearable device 420 is greater than zero, the angle at which the trainee raises the knee of the first leg may be greater than an angle at which the trainer raises the knee of the first leg. In other words, when “Y_1 - X_1” calculated by the processor 420-1 of the trainer wearable device 420 is greater than zero, the movement of the trainee may be greater than the movement of the trainer. In this case, to give the trainer feedback that the movement of the trainee is relatively large, the processor 420-1 of the trainer wearable device 420 may control the motor driver circuit 420-3 or 420-6 of the trainer wearable device 420 to rotate the motor 420-4 or 420-7 of the trainer wearable device 420 in the clockwise direction so that the resistance torque is output to the first leg of the trainer.

When “Y_1 - X_1” calculated by the processor 420-1 of the trainer wearable device 420 is less than zero, the angle at which the trainee raises the knee of the first leg may be smaller than the angle at which the trainer raises the knee of the first leg. In other words, when “Y_1 - X_1” calculated by the processor 420-1 of the trainer wearable device 420 is less than zero, the movement of the trainee may be smaller than the movement of the trainer. In this case, to give the trainer feedback that the movement of the trainee is relatively small, the processor 420-1 of the trainer wearable device 420 may control the motor driver circuit 420-3 or 420-6 of the trainer wearable device 420 to rotate the motor 420-4 or 420-7 of the trainer wearable device 420 in the counterclockwise direction so that the auxiliary torque is output to the first leg of the trainer.

In an example embodiment, the server 530 may calculate an evaluation score for the movement of the trainee by comparing movement information of the trainee with movement information of the trainer. In other words, the server 530 may evaluate whether the trainee follows the movement of the trainer well by comparing the movement information of the trainee with the movement information of the trainer.

### Self-Training

When a predetermined period of time elapses from the start of remote training between the trainee and the trainer, the server 530 may switch the remote training to the self-training and provide the trainee electronic device 510 and the trainer electronic device 520 with a notification indicating that the remote training is switched the self-training. Each of the trainee electronic device 510 and the trainer electronic device 520 may display information indicating that the remote training is switched to the self-training on a display thereof. In the self-training, the movement information of the trainer may not be transmitted to the trainee wearable device 410.

In the self-training, when the evaluation score of the trainee is greater than or equal to a predetermined reference value, the server 530 may increase an exercise intensity for the trainee by outputting a greater strength of the resistance torque to the trainee. The server 530 may transmit a control command to increase the exercise intensity to the trainee electronic device 510, and the trainee electronic device 510 may transmit the control command of the server 530 to the trainee wearable device 410. When the control command of the server 530 is received from the trainee electronic device 510, the processor 410-1 of the trainee wearable device 410 may control the resistance torque of the greater strength to be output to the trainee.

For example, the processor 410-1 may acquire the first hip-joint angle Y_1 of the trainee using the first sensor 410-2. The processor 410-1 may determine the torque intensity by multiplying the value of Y_1 by the third gain according to Equation 7 described with reference to FIG. 3C. As the foregoing, in the remote training, the torque intensity may be determined by multiplying the value of “Y_1 - X_1” by the third gain according to Equation 6. In the self-training, the torque intensity may be determined by multiplying the value of Y_1 by the third gain. Accordingly, the torque intensity may increase in the self-training. The processor 410-1 may determine a direction opposite to the rotation direction of the first hip joint of the trainee to be the torque direction. In some cases, the processor 410-1 may acquire an angular velocity of a first joint and determine the torque intensity by multiplying the magnitude of angular velocity by the second gain according to Equation 2. The processor 410-1 may determine the direction opposite to the rotation direction of the first hip joint of the trainee to be the torque direction.

The processor 410-1 may control the converter 202 to draw the power corresponding to the determined torque intensity from the battery 200. When the first hip joint of the trainee rotates in the counterclockwise direction, the processor 410-1 may turn on the first switch 210 and the fourth switch 240 of the first motor driver circuit 410-3 and turn off the second switch 220 and the third switch 230 so that the first motor 410-4 rotates in the clockwise direction. The power drawn by the converter 202 may be supplied to the first motor 410-4 so that the first motor 410-4 provides the resistance torque to the first leg. Through this, the trainee, who followed the exercise of the trainer well in the remote training, may exercise by receiving a stronger torque in the self-training, thereby achieving the exercise effect increased.

The server 530 may increase the exercise intensity of the trainee by adjusting the gain to be increased. For example, the server 530 may transmit the increased third gain to the trainee electronic device 510. The trainee electronic device 510 may transmit the increased third gain to the trainee wearable device 410. The processor 410-1 may determine the torque intensity by multiplying the value of Y_1 by the increased third gain using Equation 7, so that the resistance torque of the greater strength is output to the trainee. Through this, the trainee wearable device 410 may allow the trainee to exercise at a higher exercise intensity.

In the self-training, when the evaluation score of the trainee is less than the predetermined reference value, the server 530 may decrease the exercise intensity for the trainee by adjusting the third gain to be decreased. The server 530 may transmit a control command to decrease the third gain to the trainee electronic device 510, and the trainee electronic device 510 may transmit the control command of the server 530 to the trainee wearable device 410.

When the control command of the server 530 is received from the trainee electronic device 510, the processor 410-1 may adjust the third gain to be decreased. The processor 410-1 may acquire the first hip-joint angle Y_1 of the trainee using the first sensor 410-2. The processor 410-1 may determine the torque intensity by multiplying the value of Y_1 by the decreased third gain according to Equation 7 described with reference to FIG. 3C. The processor 410-1 of the trainee wearable device 410 may determine the direction opposite to the rotation direction of the first hip joint of the trainee to be the torque direction. In some cases, the server 530 may transmit the control command to decrease the second gain to the trainee electronic device 510, and the trainee electronic device 510 may transmit the control command of the server 530 to the trainee wearable device 410. The processor 410-1 may adjust the second gain to be decreased. The processor 410 may acquire the angular velocity of the first joint and determine the torque intensity by multiplying the magnitude of angular velocity by the decreased second gain according to Equation 2. The processor 410-1 may determine the direction opposite to the rotation direction of the first hip joint of the trainee to be the torque direction.

The processor 410-1 may control the converter 202 to draw the power corresponding to the determined torque intensity from the battery 200. When the first hip joint of the trainee rotates in the counterclockwise direction, the processor 410-1 may turn on the first switch 210 and the fourth switch 240 of the first motor driver circuit 410-3 and turn off the second switch 220 and the third switch 230 so that first motor 410-4 rotates in the clockwise direction. The power drawn by the converter 202 may be supplied to the first motor 410-4 so that the first motor 410-4 provides a resistance torque at a relatively low intensity to the first leg. Through this, the trainee, who failed in following the exercise of the trainer well in the remote training, may exercise by receiving the resistance torque of the relatively low intensity in the self-training, thereby performing an exercise optimized for a physical condition of the trainee.

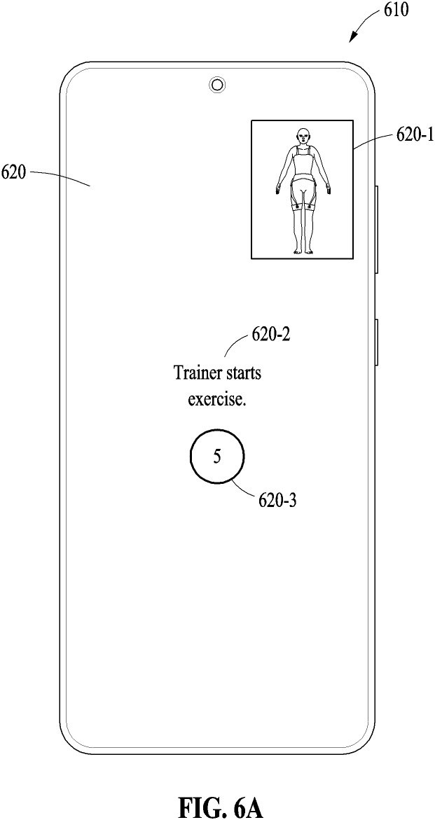

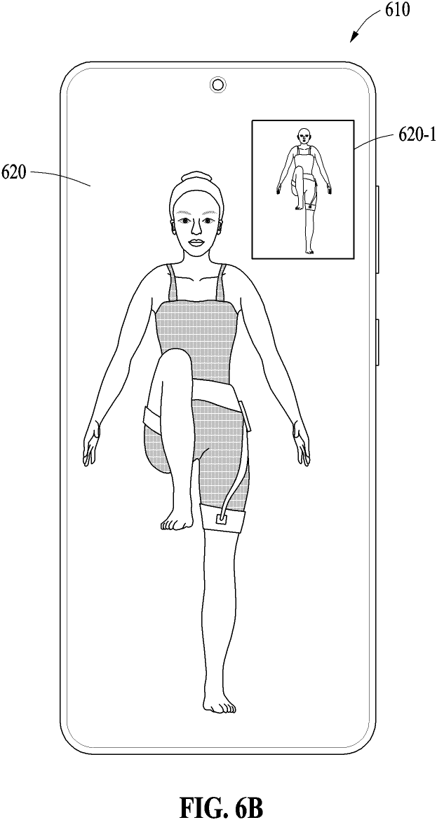

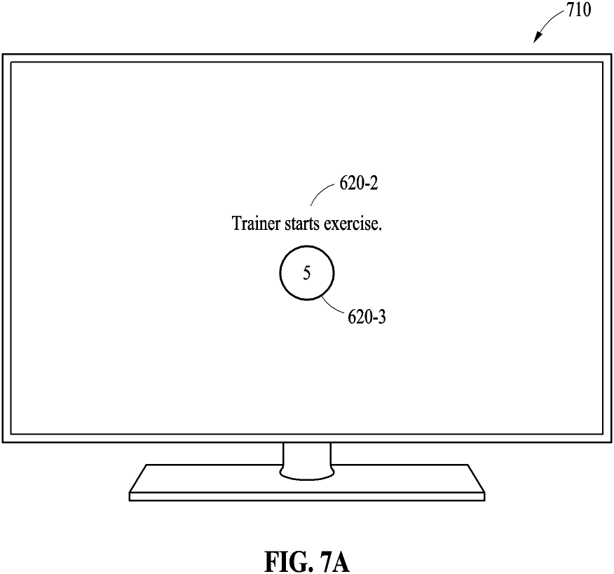

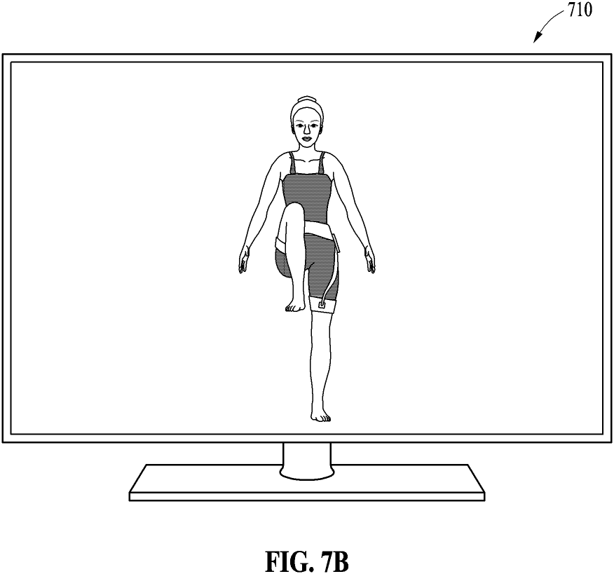

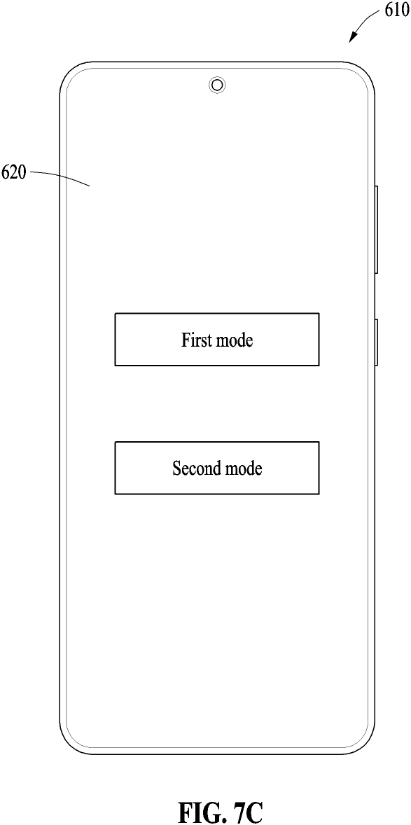

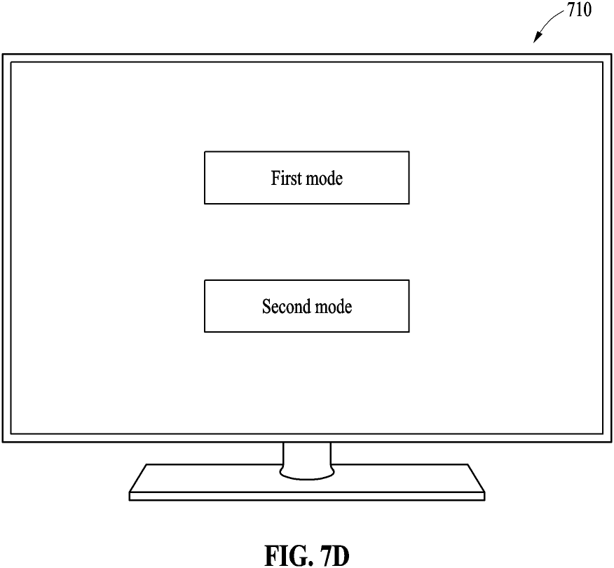

FIGS. 6A, 6B, 7A, 7B, 7C and 7D are diagrams illustrating a screen of a trainee electronic device according to an example embodiment.

The trainee electronic device 510 may include a mobile device 610 and a display device 710. The mobile device 610 may include, for example, a smartphone or a tablet terminal, and the display device 710 may include a smart TV.

FIGS. 6A and 6B illustrate a screen of the mobile device 610 when the trainee electronic device 510 is the mobile device 610, and FIGS. 7A and 7B illustrate a screen of the display device 710 when the trainee electronic device 510 is the display device 710.

Referring to FIG. 6A, the mobile device 610 of the trainee may include a display 620.

In an area 620-1, an image obtained by a camera of the mobile device 610 by capturing the trainee may be displayed.

The mobile device 610 may inform the trainee that the trainer starts exercising. For example, the mobile device 610 may receive temporally synchronized audio data, image data, and first hip-joint angle X_1 from the server 530. In this case, as illustrated in the example of FIG. 6A, the mobile device 610 may display a message 620-2 “trainer starts exercising” and a remaining time 620-3 on the display 620. Here, the remaining time 620-3 may refer to a period of time remaining until image data of the trainer is displayed. As such, based on visual information, the trainee may acknowledge that the trainer starts exercising.

When the remaining time 620-3 elapses, the mobile device 610 may display the image data of the trainer on the display 620 as illustrated in the example of FIG. 6B. In other words, the mobile device 610 may display an exercise image of the trainer on the display 620. In addition, the mobile device 610 may output audio data through a speaker and transmit the first hip-joint angle X_1 of the trainer to the trainee wearable device 410.

The mobile device 610 may display an exercise image of the trainee in the area 620-1.

The mobile device 610 may calculate calories consumed by the trainee based on a type of exercise and exercise time related to an exercise that the trainee is currently performing, and may display the calculated calories on the display 620. In some cases, the server 530 may calculate calories consumed by the trainee based on a type of exercise and exercise time related to an exercise that the trainee is currently performing, and may transmit the calculated calories to the mobile device 610. The mobile device 610 may display the calories received from the server 530 on the display 620.

The trainee may wear a smartwatch capable of measuring a heart rate, and the smartwatch may be connected to the mobile device 610 via the short-range wireless communication link. The smartwatch may measure a heart rate of the trainee and transmit the measured heart rate to the mobile device 610. The mobile device 610 may display the measured heart rate on the display 520.

In the example of FIG. 7A, the display device 710 may inform the trainee that the trainer starts exercising. For example, the display device 710 may receive temporally synchronized audio data, image data, and first hip-joint angle X_1 from the server 530. In this case, as illustrated in the example of FIG. 7A, the display device 710 may display the message 620-2 “trainer starts exercising” and the remaining time 620-3 on the display 620. As such, based on visual information, the trainee may acknowledge that the trainer starts exercising.

When the remaining time 620-3 elapses, the display device 710 may display the image data of the trainer as illustrated in the example of FIG. 7B. In other words, the display device 710 may display an exercise image of the trainer. In addition, the display device 710 may output audio data through a speaker and transmit the first hip-joint angle X_1 to the trainee wearable device 410.

The display device 710 may calculate calories consumed by the trainee based on a type of exercise and exercise time related to an exercise that the trainee is currently performing, and may display the calculated calories. In some cases, the server 530 may calculate calories consumed by the trainee based on a type of exercise and exercise time related to an exercise that the trainee is currently performing, and may transmit the calculated calories to the display device 710. The display device 710 may display the calories received from the server 530.

The trainee may wear a smartwatch capable of measuring a heart rate, and the smartwatch may be connected to the display device 710 via the short-range wireless communication link. The smartwatch may measure a heart rate of the trainee and transmit the measured heart rate to the display device 710. The display device 710 may display the measured heart rate.

Unlike the examples described with reference to FIGS. 7A and 7B, in the remote training system, the display device 710 may perform screen mirroring. For example, the mobile device 610 may be connected to the display device 710 through Wi-Fi Direct or Bluetooth. The mobile device 610 may receive temporally synchronized audio data, image data, and first hip-joint angle X_1 from the server 530, and may display the audio data. At this time, the mobile device 610 may display the screen of the mobile device 610 on the display device 710 through the screen mirroring.

In an example embodiment, as illustrated in the examples of FIGS. 7C and 7D, a soft button for a first mode and a soft button for a second mode may be exposed on the display of the trainee electronic device 510.

The first mode may be a mode in which the trainee wearable device 410 provides a torque to the trainee so that the trainee follows the movement of the trainer. In the first mode, the trainee may receive the auxiliary torque from the trainee wearable device 410 as described with reference to FIG. 5. For example, when the trainee selects the first mode, the trainee electronic device 510 may transmit a control command to the trainee wearable device 410 so that the trainee wearable device 410 operates in the first mode. The processor 410-1 of the trainee wearable device 410 may operate in the first mode according to the control command of the trainee electronic device 510.

In the first mode, when the first hip-joint angle Y_1 of the trainee is less than the first hip-joint angle X_1 of the trainer, the processor 410-1 of the trainee wearable device 410 may determine the torque intensity by multiplying the value of ““Y_1 - X_1” by a gain. The gain may be, for example, the third gain described with reference to FIG. 3C but is not limited thereto.

The processor 410-1 of the trainee wearable device 410 may control the converter 202 to draw power corresponding to the determined torque intensity from the battery 200. In addition, the processor 410-1 of the trainee wearable device 410 may control the first motor driver circuit 410-3 such that the first motor 410-4 rotates in the same direction as the rotation direction of the first hip joint of the trainee. Through this, the trainee wearable device 410 may guide the exercise posture of the trainee to be close to the exercise posture of the trainer in the first mode.

The second mode may be a mode in which the trainee wearable device 410 provides a notification on a timing of giving the movement to the trainee to satisfy the trainee in a case in which the trainee cannot follow the movement of the trainer 100% due to a physical capability and a case in which the trainee wants timing training of simple movements. In the second mode, the trainee may receive the movement timing from the trainee wearable device 410 by receiving a torque of a relatively low intensity even if the trainee fails to completely follow the exercise posture of the trainer.

When the trainee selects the second mode, the trainee electronic device 510 may transmit a control command to the trainee wearable device 410 such that the trainee wearable device 410 operates in the second mode. The processor 410-1 of the trainee wearable device 410 may operate in the second mode according to the control command of the trainee electronic device 510.

In the second mode, the processor 410-1 of the trainee wearable device 410 may inform the trainee of a timing to move the first leg using the first hip-joint angle X_1 of the trainer. For example, when the first hip-joint angle X_1 of the trainer increases, the processor 410-1 of the trainee wearable device 410 may guide the trainee to raise the first leg by outputting the torque of the relatively low intensity to the first leg of the trainee. In other words, when the first hip-joint angle X_1 of the trainer increases, the processor 410-1 of the trainee wearable device 410 may inform the trainee of a timing to raise the first leg by outputting the torque of the relatively low intensity. When the first hip-joint angle X_1 of the trainer decreases while the trainee raises the first leg, the processor 410-1 of the trainee wearable device 410 may output the torque of the relatively low intensity to the first leg of the trainee to guide the trainee to lower the first leg. In other words, when the first hip-joint angle X_1 of the trainer decreases while the trainee raises the first leg, the processor 410-1 of the trainee wearable device 410 may inform the trainee of a timing to lower the first leg by outputting the torque of the relatively low intensity. In the second mode, the trainee may receive the movement timing from the trainee wearable device 410 based on the torque of the relatively low intensity.

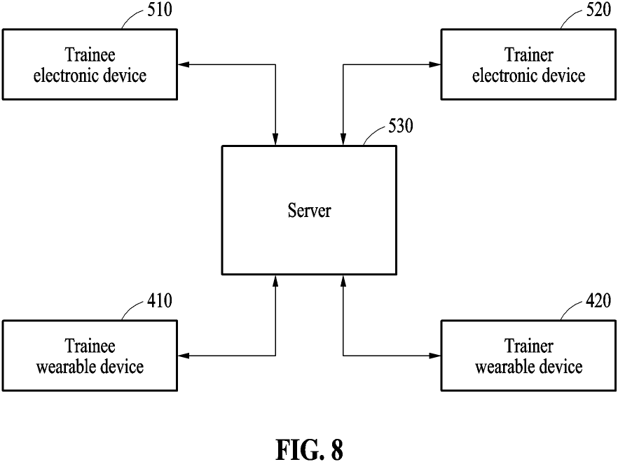

FIG. 8 is a diagram illustrating another example of a remote training system according to an example embodiment.

Referring to FIG. 8, a remote training system may include the trainee wearable device 410, the trainer wearable device 420, the trainee electronic device 510, the trainer electronic device 520, and the server 530. Unlike the example described with reference to

FIG. 5, the trainee wearable device 410 may communicate with the server 530 through a mobile communication circuit or a Wi-Fi communication circuit, and the trainer wearable device 420 may communicate with the server 530 through a mobile communication circuit or a Wi-Fi communication circuit.

As described with reference to FIG. 4C, it is assumed that the trainer and the trainee raise and lower the knees of the first legs. When the trainer and the trainee raise the knees of the first legs upward, the hip joint of the first leg (e.g., the first hip joint) of each of the trainer and the trainee may rotate in the counterclockwise direction.

The trainer electronic device 520 may generate audio data and image data by capturing the trainer exercising and transmit the audio data and the image data to the server 530.

The processor 420-1 of the trainer wearable device 420 may acquire the first hip-joint angle X_1 of the trainer using the first sensor 420-2 and transmit the first hip-joint angle X_1 of the trainer to the server 530 using a mobile communication circuit or a wireless LAN communication circuit.

In order to prevent a discrepancy between audio/video data and hip angle data which may be caused by a difference in data sampling time the trainer electronic device 520 and the trainer wearable device 420, the server 530 may perform time synchronization on the audio data, the image data, and the first hip-joint angle X_1 of the trainer. Since the audio data and the image data are generated by the trainer electronic device 520 and the first hip-joint angle X_1 is generated by the trainer wearable device 420, an entity that generates the audio data and the image data is different from an entity that generates the first hip-joint angle X_1. Accordingly, the server 530 may temporally synchronize a trainer’s voice, a trainer’s movement shown in an image, and the first hip-joint angle X_1. For example, the audio data and the image data may have time values ta, tb, tc, etc. In this example, among the time values ta, tb, tc, etc. of the audio data and the image data, ta may be the earliest. In addition, the first hip-joint angle X_1 may have time values ta, tb, tc, etc. The server 530 may synchronize the audio data, the image data, and the first hip-joint angle X_1 based on ta.

The server 530 may transmit the audio data and the image data to the trainee electronic device 510 and transmit the first hip-joint angle X_1 to the trainee wearable device 410.

The trainee electronic device 510 may display the image data received from the server 530 and output the audio data through a speaker.

The processor 410-1 of the trainee wearable device 410 may set the first hip-joint angle X_1 of the trainer received from the server 530 to be a threshold angle.

The processor 410-1 of the trainee wearable device 410 may acquire the first hip-joint angle Y_1 of the trainee using the first sensor 410-2.

The processor 410-1 of the trainee wearable device 410 may calculate a difference “Y_1 - X_1” between the first hip-joint angle Y_1 of the trainee and the threshold angle X_1.

When the calculated difference ““Y_1 - X_1” is greater than or equal to zero, the processor 410-1 of the trainee wearable device 410 may control the first motor driver circuit 410-3 to rotate the first motor 410-4 of the trainee wearable device 410 in the clockwise direction so that the resistance torque is output to the first leg of the trainee. Through this, the trainee wearable device 410 may guide the trainee to lower the knee of the first leg. The description of FIG. 5 may apply here, and redundant description will be omitted.

When the calculated difference “Y_1 - X_1” is less than zero, the processor 410-1 of the trainee wearable device 410 may not provide a torque to a user. As another example, when the calculated difference “Y_1 - X_1” is less than zero, the processor 410-1 of the trainee wearable device 410 may control the first motor driver circuit 410-3 to rotate the first motor 410-4 of the trainee wearable device 410 in the counterclockwise direction so that the auxiliary torque is output to the first leg of the trainee. Through this, the trainee wearable device 410 may guide the trainee to raise the knee of the first leg higher.

The description of FIG. 5 may apply here, and redundant description will be omitted.

Since the descriptions of FIGS. 1A through 7B may apply to the example of FIG. 8, redundant description will be omitted.

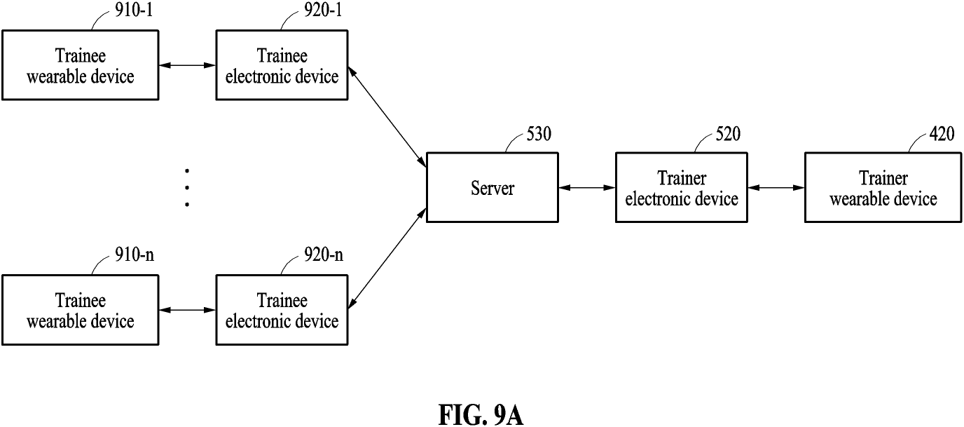

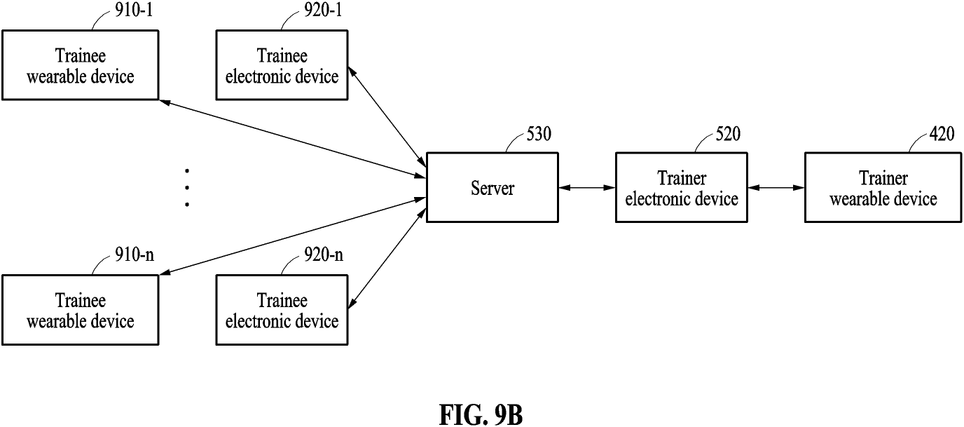

FIGS. 9A and 9B are diagrams illustrating still another example of a remote training system according to an example embodiment.

The remote training system described with reference to FIGS. 5 through 8 may correspond to a one-to-one remote training system. Not limited thereto, as illustrated in examples of FIGS. 9A and 9B, a one-to many remote training system including the plurality of trainee wearable devices 910-1 through 910-n may be implemented. Even when trainees and a trainer are located in different spaces, each of the trainees may learn exactly what the trainer intends, based on a torque (or force) transmitted through a wearable device of the corresponding trainee.

Constituent elements of each of the trainee wearable devices 910-1 through 910-n may be the same as constituent elements of the trainee wearable device 410, and redundant description of the constituent elements of each of the trainee wearable devices 910-1 through 910-n will be omitted.

In the example illustrated in FIG. 9A, the plurality of trainee wearable devices 910-1 through 910-n may be respectively connected to a plurality of trainee electronic devices 920-1 through 920-n through a short-range wireless communication link, and each of the plurality of trainee electronic devices 920-1 through 920-n may communicate with the server 530. The description made about the operation of the trainee wearable device 410 with reference to FIG. 5 may apply to operations of the plurality of trainee wearable devices 910-1 through 910-n of FIG. 9A, and redundant description will be omitted. The description made about the operation of the trainee electronic device 510 with reference to FIGS. 5 and 6 may apply to operations of the plurality of trainee electronic devices 920-1 through 920-n of FIG. 9A, and redundant description will be omitted.

In the example of FIG. 9A, the server 530 may calculate evaluation scores for movements of the trainees by comparing movement information on the trainees to movement information of the trainer, determine rankings of the trainers based on the calculated evaluation scores, and generate ranking information including the determined rankings of the trainees. The server 530 may transmit the ranking information to each of the trainee electronic devices 920-1 through 920-n. Each of the trainee electronic devices 920-1 through 920-n may display the ranking information on a display. The remote training system of FIG. 9A may make the trainees feel competitive by providing the ranking information, so that the trainees participate more actively in the exercise.

In the example illustrated in FIG. 9B, each of the plurality of trainee wearable devices 910-1 through 910-n may communicate with the server 530. The description made about the operation of the trainee wearable device 410 with reference to FIG. 8 may apply to operations of the plurality of trainee wearable devices 910-1 through 910-n of FIG. 9B, and redundant description will be omitted. The description made about the operation of the trainee electronic device 510 with reference to FIG. 8 may apply to operations of the plurality of trainee electronic devices 920-1 through 920-n of FIG. 9B, and redundant description will be omitted.

In the example of FIG. 9B, the server 530 may generate the ranking information including the rankings of the trainees as described with reference to FIG. 9A. The server 530 may transmit the ranking information to each of the trainee wearable devices 910-1 through 910-n and display the ranking information. The remote training system of FIG. 9B may make the trainees feel competitive by providing the ranking information, so that the trainees participate more actively in the exercise.

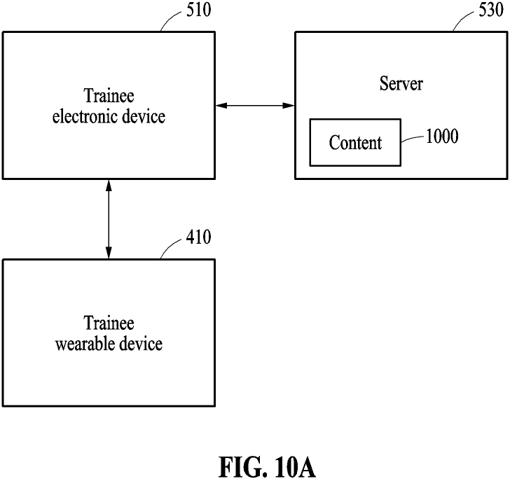

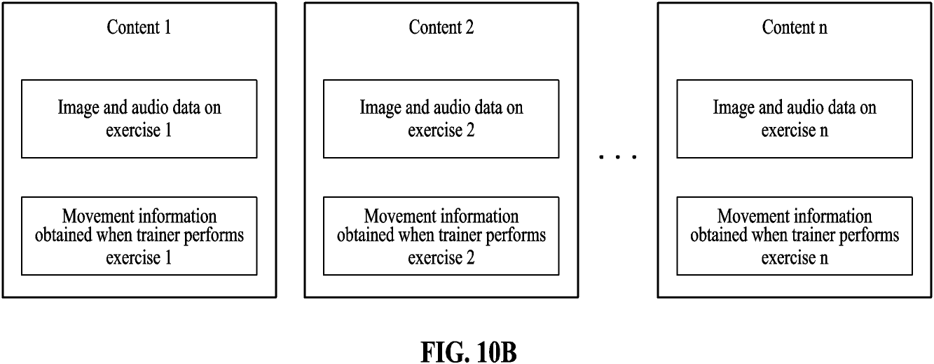

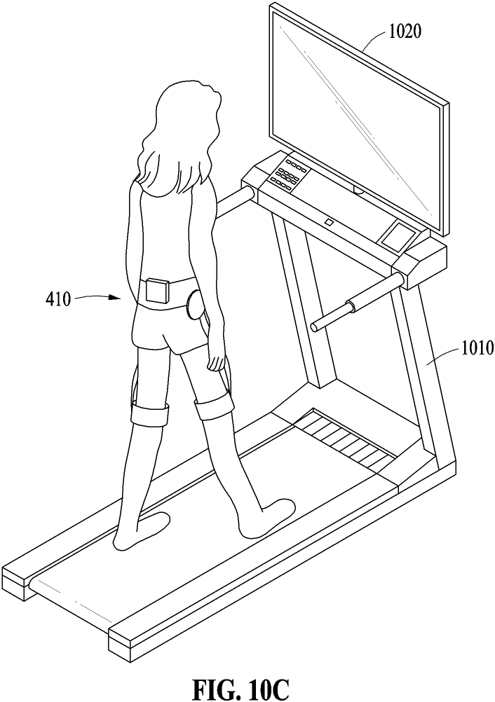

FIGS. 10A and 10B are diagrams illustrating a streaming-based training system according to an example embodiment.

In the above-described remote training system, the trainee wearable device 410 may allow a trainee to learn an exercise accurately by providing the trainee with a force based on a difference between a real-time movement of a trainer and a real-time movement of the trainee. In other words, in the above-described remote training system, the trainee wearable device 410 may allow the trainee to accurately exercise following the real-time movement of the trainer as a reference. In the below-described streaming-based training system, the trainee may receive an exercise guide according to streamed content and torque (or force) received through the trainee wearable device 410 so as to learn exactly the movement on the content. In addition, in the streaming-based training system, the trainee may receive the exercise guide without restrictions on time and location.

Referring to FIG. 10A, the streaming-based training system includes the trainee wearable device 410, the trainee electronic device 510, and the server 530.

In an example of FIG. 10A the server 530 may correspond to a cloud server but is not limited thereto.

The server 530 may store a plurality of contents. In other words, the contents may be stored in a cloud. Each of the contents may include image data and audio data for each exercise of the trainer. In addition, each of the contents may include movement information obtained when the trainer performs each exercise. In an example illustrated in FIG. 10B, content 1 may include image and audio data on an exercise 1 of the trainer and include movement information obtained when the trainer wearing the trainer wearable device 420 performs the exercise 1. The movement information obtained when the trainer performs the exercise 1 may include a joint angle of the trainer obtained by the processor 420-1 of the trainer wearable device 420 using the first sensor 420-2 and/or the second sensor 420-5 while the trainer performs the exercise 1. Content 2 may include image and audio data on an exercise 2 of the trainer and include movement information obtained when the trainer wearing the trainer wearable device 420 performs the exercise 2. The movement information obtained when the trainer performs the exercise 2 may include a joint angle of the trainer obtained by the processor 420-1 of the trainer wearable device 420 using the first sensor 420-2 and/or the second sensor 420-5 while the trainer performs the exercise 2. Content n may include image and audio data on an exercise n of the trainer and include movement information obtained when the trainer wearing the trainer wearable device 420 performs the exercise n. The movement information obtained when the trainer performs the exercise n may include a joint angle of the trainer obtained by the processor 420-1 of the trainer wearable device 420 the first sensor 420-2 and/or the second sensor 420-5 while the trainer performs the exercise n.

Referring back to FIG. 10A, when connected to the server 530, the trainee electronic device 510 may receive a content list from the server 530 and display the received content list on the trainee electronic device 510.

The trainee may select content 1000 from the content list displayed on the trainee electronic device 510. The content 1000 may be content for the exercise described with reference to FIG. 4C. The content 1000 may include the first hip-joint angle X_1 obtained when the trainer wearing the trainer wearable device 420 performs the exercise described with reference to FIG. 4C, and image data and audio data acquired by a camera capturing the exercise of the trainer.

When the trainee selects the content 1000, the trainee electronic device 510 may request the server 530 to stream the content 1000.

The server 530 may stream the content 1000 to the trainee electronic device 510. In other words, the server 530 may transmit the image data, the audio data, and the first hip-joint angle X_1 of the trainer to the trainee electronic device 510.

The trainee electronic device 510 may display the image data and output the audio data through a speaker. In addition, the trainee electronic device 510 may extract the first hip-joint angle X_1 from the content 1000 and transmit the extracted first hip-joint angle X_1 to the trainee wearable device 410.

The processor 410-1 of the trainee wearable device 410 may set the first hip-joint angle X_1 to be a threshold angle.

The processor 410-1 of the trainee wearable device 410 may acquire the first hip-joint angle Y_1 of the trainee using the first sensor 410-2.

The processor 410-1 of the trainee wearable device 410 may calculate a difference “Y_1 - X_1” between the first hip-joint angle Y_1 of the trainee and the threshold angle X_1.

When the calculated difference “Y_1 - X_1” is greater than zero, the processor 410-1 of the trainee wearable device 410 may control the first motor driver circuit 410-3 to rotate the first motor 410-4 of the trainee wearable device 410 in the clockwise direction so that the resistance torque is output to the first leg of the trainee. Through this, the trainee wearable device 410 may guide the trainee to lower the knee of the first leg. The description of FIG. 5 may apply here, and redundant description will be omitted.

When the calculated difference “Y_1 - X_1” is less than zero, the processor 410-1 of the trainee wearable device 410 may not provide a torque to a user. As another example, when the calculated difference “Y_1 - X_1” is less than zero, the processor 410-1 of the trainee wearable device 410 may control the first motor driver circuit 410-3 to rotate the first motor 410-4 of the trainee wearable device 410 in the counterclockwise direction so that the auxiliary torque is output to the first leg of the trainee. Through this, the trainee wearable device 410 may guide the trainee to raise the knee of the first leg higher. The description of FIG. 5 may apply here, and redundant description will be omitted.

In an example illustrated in FIG. 10C, content related to walking movement may be reproduced on a display device 1020. The trainee may perform the walking movement on a treadmill 1010. When a walking posture of the trainee is different from a walking posture of the trainer on the content, the trainee may receive a torque through the trainee wearable device 410 so as to learn a correct posture of the walking movement. The example of FIG. 10C will be described in detail below.

The server 530 may stream content including the image data and audio data related to the walking movement, a right hip-joint angle X_right of the trainer, and a left hip-joint angle X_left of the trainer to the display device 1020.

The display device 1020 may display the image data related to the walking movement and output the audio data through a speaker. The display device 1020 may extract the right hip-joint angle X_right and the left hip-joint angle X_left of the trainer from the content received from the server 530 and transmit the extracted right hip-joint angle X_right and left hip-joint angle X_left to the trainee wearable device 410.

The processor 410-1 of the trainee wearable device 410 may acquire a right hip-joint angle Y_right of the trainee using the first sensor 410-2 and acquire the left hip-joint angle Y_left of the trainee using the second sensor 410-5.

The processor 410-1 of the trainee wearable device 410 may set the right hip-joint angle X_right of the trainer to be the trainee to be a threshold angle for a right leg and set the left hip-joint angle X_left of the trainer to be a threshold angle for a left leg of the trainee.

The processor 410-1 of the trainee wearable device 410 may calculate a difference “Y_right - X_right” between the right hip-joint angle Y_right of the trainee and the threshold angle X_right for the right leg.

When the calculated difference “Y_right - X_right” is greater than zero, the processor 410-1 of the trainee wearable device 410 may determine a torque intensity by multiplying a value of “Y_right - X_right” by the third gain according to Equation 6, and determine a direction opposite to a rotation direction of the right hip joint of the trainee to be a torque direction. The processor 410-1 may control the converter 202 such that the converter 202 draws power corresponding to the determined torque intensity from the battery 200. When the rotation direction of the right hip joint of the trainee is the clockwise direction, the processor 410-1 may turn on the second switch 220 and the third switch 230 of the first motor driver circuit 410-3 and turn off the first switch 210 and the fourth switch 240 so that the first motor 410-4 rotates in the counterclockwise direction. The power drawn by the converter 202 may be supplied to the first motor 410-4 so that the first motor 410-4 provides the resistance torque to the right leg.

When the calculated difference “Y _right - X_right” is less than zero, the processor 410-1 of the trainee wearable device 410 may not provide a torque to the right leg. As another example, when the calculated difference ““Y_right - X_right” is less than zero, the processor 410-1 of the trainee wearable device 410 may determine a torque intensity by multiplying the value of “Y _right - X _right” by the fourth gain according to Equation 10, and determine the rotation direction of the right hip joint of the trainee to be the torque direction. The processor 410-1 may control the converter 202 such that the converter 202 draws power corresponding to the determined torque intensity from the battery 200. When the rotation direction of the right hip joint of the trainee is the clockwise direction, the processor 410-1 may turn on the first switch 210 and the fourth switch 240 of the first motor driver circuit 410-3 and turn off the second switch 220 and the third switch 230 so that the first motor 410-4 rotates in the clockwise direction. The power drawn by the converter 202 may be supplied to the first motor 410-4 so that the first motor 410-4 provides the auxiliary torque to the right leg.

The processor 410-1 of the trainee wearable device 410 may calculate a difference “Y_left - X_left” between the left hip-joint angle Y_left of the trainee and the threshold angle X_left for the left leg.

When the calculated difference “Y_left - X_left” is greater than zero, the processor 410-1 of the trainee wearable device 410 may determine a torque intensity by multiplying a value of “Y_left - X_left” by the third gain according to Equation 6, and determine a direction opposite to a rotation direction of the left hip joint of the trainee to be the torque direction. The processor 410-1 may control the converter 202 such that the converter 202 draws power corresponding to the determined torque intensity from the battery 200. When the rotation direction of the left hip joint of the trainee is the counterclockwise direction, the processor 410-1 may turn on the fifth switch 250 and the eighth switch 280 of the second motor driver circuit 410-6 and turn off the sixth switch 260 and the seventh switch 270 so that the second motor 410-7 rotates in the clockwise direction. The power drawn by the converter 202 may be supplied to the second motor 410-7 so that the second the first motor 410-4 provides the resistance torque to the left leg.

When the calculated difference “Y_left -X_left” is less than zero, the processor 410-1 of the trainee wearable device 410 may not provide a torque to the left leg. As another example, when the calculated difference “Y_left -X_left” is less than zero, the processor 410-1 of the trainee wearable device 410 may determine the torque intensity by multiplying the value of “Y_left -X_left” by the fourth gain according to Equation 10, and determine the rotation direction of the left hip joint of the trainee to be the torque direction. The processor 410-1 may control the converter 202 such that the converter 202 draws power corresponding to the determined torque intensity from the battery 200. When the rotation direction of the left hip joint of the trainee is the counterclockwise direction, the processor 410-1 may turn on the sixth switch 260 and the seventh switch 270 of the second motor driver circuit 410-6 and turn off the fifth switch 250 and the eighth switch 280 so that the second motor 410-47 rotates in the counterclockwise direction. The power drawn by the converter 202 may be supplied to the second motor 410-7 so that the second motor 410-7 provides the auxiliary torque to the left leg.

Since the descriptions of FIGS. 1A through 9B may apply to the descriptions of FIGS. 10A and 10B, redundant description will be omitted.

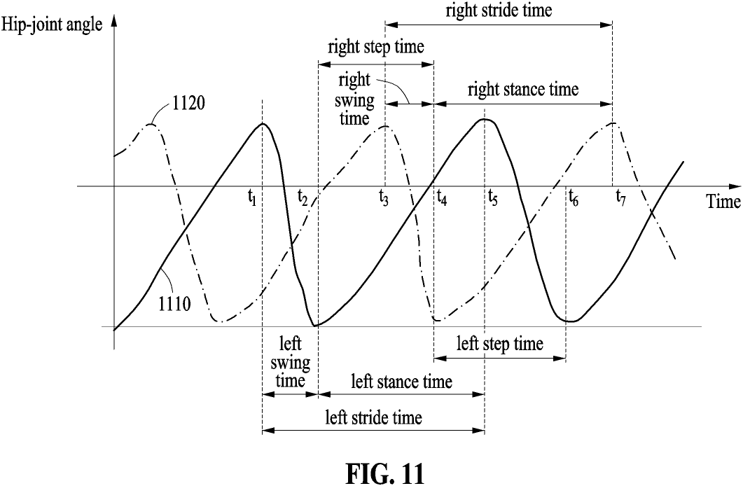

FIG. 11 is a diagram illustrating exercise analysis and evaluation according to an example embodiment.

An example of the server 530 analyzing and evaluating a walking movement of a trainee is described with reference to FIG. 11.

The processor 410-1 of the trainee wearable device 410 may acquire the right hip-joint angle Y_right using the first sensor 410-2 and acquire the left hip-joint angle Y_left using the second sensor 410-5. In addition, the IMU sensor 410-8 of the trainee wearable device 410 may acquire acceleration information, angular velocity information, and posture information on the trainee.

The communication circuit 410-9 of the trainee wearable device 410 may transmit the right hip-joint angle Y_right, the left hip-joint angle Y_left, the acceleration information, the angular velocity information, and the posture information to the server 530. In some cases, the communication circuit 410-9 of the trainee wearable device 410 may transmit the right hip-joint angle Y _right, the left hip-joint angle Y _left, the acceleration information, the angular velocity information, and the posture information to the trainee electronic device 510, and the trainee electronic device 510 may transmit the right hip-joint angle Y _right, the left hip-joint angle Y _left, the acceleration information, the angular velocity information, and the posture information to the server 530.

The server 530 may determine a primary gait feature of the trainee based on one or more of the right hip-joint angle Y _right of the trainee, the left hip-joint angle Y _left, the acceleration information, the angular velocity information, and the posture information. The primary gait feature may include, for example, steps per minute (e.g., cadence), a step width indicating a distance between centers of heels of both feet, a swing time of each leg, a stance time, a stride time, and a step time. Here, the swing time refers to a period of time for which a leg is away from the ground, and the stance time refers to a period of time for which the leg is in contact with the ground. In addition, the stride time refers to an interval between a point in time at which a heel of a leg is off the ground and a point in time at which the heel of the leg comes off the ground again. The step time refers to an interval between a point in time at which a heel of a leg is off the ground and a point in time at which a heel of another leg comes off the ground. A description of such will be made in detail with reference to FIG. 13.

In FIG. 11, a graph 1110 represents a trajectory of the left hipjoint angle Y _left, and a graph 1120 represents a trajectory of the right hip-joint angle Y_right.

In the graph 1110, the server 530 may calculate a difference between a first negative peak value time t2 and a first positive peak value time t1 to be the swing time of the left leg, calculate a difference between a second positive peak value time t5 and the first negative peak value time t2 to be the stance time of the left leg, and calculate a difference between the second positive peak value time t5 and the first positive peak value time t1 (or a sum of the swing time of the left leg and the stance time of the left leg) to be the stride time of the left leg.

In the graph 1120, the server 530 may calculate a difference between a second negative peak value time t4 and a second positive peak value time t3 to be the swing time of the right leg, calculate a difference between a third positive peak value time t7 and the second negative peak value time t4 to be the stance time of the right leg, and calculate a difference between the third positive peak value time t7 and the second positive peak value time t3 (or a sum of the swing time of the right leg and the stance time of the right leg) to be the stride time of the right leg.

The server 530 may calculate a difference between a second negative peak value time t6 of the graph 1110 and the second negative peak value time t4 and the graph 1120 to be the step time of the left leg. The server 530 may calculate a difference between the second negative peak value time t4 of the graph 1120 and the first negative peak value time t2 of the graph 1110 to be the step time of the right leg.

The server 530 may determine a maximum value among the positive peak values of the graph 1110 as a maximum flexion angle of a left thigh and determine a minimum value among the negative peak values of the graph 1110 to be a maximum extension angle of the left thigh. The server 530 may determine the maximum flexion angle and the maximum extension angle of the left thigh to be a range of motion of the left hip joint. In addition, the server 530 may determine a maximum value among the positive peak values of the graph 1120 to be a maximum flexion angle of the right thigh and determine a minimum value among the negative peak values of the graph 1120 to be a maximum extension angle of the right thigh. The server 530 may determine the maximum flexion angle and the maximum extension angle of the right thigh as the range of motion of the right hip joint.

The server 530 may calculate a gait velocity of the trainee by integrating the acceleration information of the trainee and calculate a variance value of the gait velocity. In addition, the server 530 may calculate a step length of each leg by multiplying the calculated the gait velocity by the step time of each leg, and may calculate a variance value of the step length of each leg. Also, the server 530 may calculate a stride length of each leg by multiplying the calculated the gait velocity by the stride time of each leg.

The server 530 may calculate the cadence of the trainee based on an once swing time of one leg of the trainee. For example, when the once swing time of one leg is a time T_{swing}, the server 530 may obtain 60/T_{swing} as the cadence of the trainee.

The server 530 may determine a secondary gait feature used to directly evaluate the gait ability of the trainee based on the primary gait feature of the trainee. The secondary gait feature may include, for example, a gait symmetry, a gait age, and the like. The gait symmetry may indicate a degree to which both legs of the trainee are symmetrical while walking.

The server 530 may determine the gait symmetry of the trainee based on the stance times and the swing times of both legs. As an example, the server 530 may determine the gait symmetry according to Equation 12.

$$\text{symmetry=log} \left(\text{L\_ratio/R\_ratio}\right) \qquad \text{[Equation 12]}$$

In Equation 12, L_ratio denotes the stance time of the left leg/the swing time of the left leg, and R_ratio denotes the stance time of the right leg/the swing time of the right leg.

If a gait of the trainee is close to a symmetrical gait, the gait symmetry may be calculated close to zero according to Equation 12.

As another example, the server 530 may determine the gait symmetry of the trainee based on the range of motion of both hip joints. For example, the server 530 may calculate a difference between the maximum flexion angle of the left thigh and the maximum flexion angle of the right thigh, and calculate a difference between the maximum extension angle of the left thigh and the maximum extension angle of the right thigh. When the difference between the maximum flexion angle of the left thigh and the maximum flexion angle of the right thigh and the difference between the maximum extension angle of the left thigh and the maximum extension angle of the right thigh are each calculated close to zero, the server 530 may determine that the trainee is walking symmetrically.

The server 530 may determine a gait exercise suitable for the trainee based on the secondary gait feature of the trainee and recommend the determined gait exercise to the trainee.

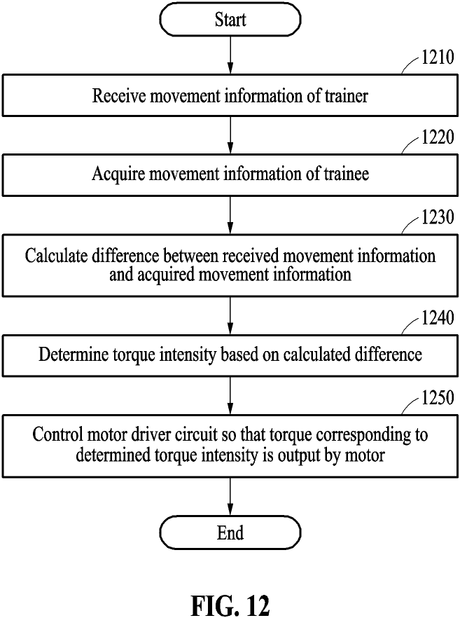

FIG. 12 is a flowchart illustrating an operation method of a trainee wearable device according to an example embodiment.

Referring to FIG. 12, in operation 1210, the communication circuit 410-9 of the trainee wearable device 410 receives movement information of a trainer from the server 530 or the trainee electronic device 510. The movement information of the trainer may include, for example, a joint angle of the trainer.

As an example, the movement information of the trainer may be generated by sensing a movement of the trainer in the first sensor 420-2 of the trainer wearable device 420 located remotely.

As another example, the trainee electronic device 510 may receive content from the server 530 through streaming. At this time, the content may include image data and audio data generated by capturing the movement of the trainer in advance, and include movement information generated by the trainer wearable device 420 sensing the movement of the trainer. The trainee electronic device 510 may extract the movement information of the trainer from the content and transmit the extracted movement information to the trainee wearable device 410.

In operation 1220, the processor 410-1 of the trainee wearable device 410 acquires movement information of a trainee using the first sensor 410-2. The movement information of the trainee may include, for example, a joint angle of the trainee.

In operation 1230, the processor 410-1 of the trainee wearable device 410 calculates a difference between the received movement information and the acquired movement information. The processor 410-1 of the trainee wearable device 410 may calculate “the acquired movement information-the received movement information.” In the example of FIG. 12, it is described that the processor 410-1 of the trainee wearable device 410 calculates a difference between the received movement information and the acquired movement information. Not limited thereto, as described above, the processor 410-1 of the trainee wearable device 410 may set the received movement information to be reference information and calculate a difference between the set reference information and the acquired movement information.

In operation 1240, the processor 410-1 of the trainee wearable device 410 determines a torque intensity based on the calculated difference. As an example, when “the acquired movement information-the received movement information” is greater than a predetermined value (for example, 0), the processor 410-1 of the trainee wearable device 410 may identify a gain (for example, the third gain described above) for increasing the torque intensity and determine a torque intensity using the identified gain and “the acquired movement information-the received movement information.” In addition, when “the acquired movement information-the received movement information” is greater than the predetermined value, the processor 410-1 of the trainee wearable device 410 may determine a direction opposite to a direction of a movement of the trainee to be a torque direction. When “the acquired movement information-the received movement information” is less than the predetermined value, the processor 410-1 of the trainee wearable device 410 may identify a gain (for example, the fourth gain described above) for increasing the torque intensity, and determine the torque intensity using the identified gain and “the acquired movement information-the received movement information.” In addition, when “the acquired movement information-the received movement information” is less than the predetermined value, the processor 410-1 of the trainee wearable device 410 may determine the same direction as the direction of the movement of the trainee to be the torque direction.

In operation 1250, the processor 410-1 of the trainee wearable device 410 controls a motor driver circuit so that a torque corresponding to the determined torque intensity is output by the first motor 410-4. For example, the processor 410-1 of the trainee wearable device 410 may control the converter 202 such that the converter 202 draws power corresponding to the determined torque intensity from the battery 200. The processor 410-1 of the trainee wearable device 410 may turn on a portion of switches of the first motor driver circuit 410-3 and turn off remaining switches such that the motor rotates in the determined torque direction and outputs the torque.

Since the descriptions of FIGS. 1A through 11 may apply to the example of FIG. 12, redundant description will be omitted.

The example embodiments described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter.

The above-described hardware devices may be configured to act as one or more software modules in order to perform the operations of the above-described example embodiments, or vice versa.

While this disclosure includes specific example embodiments, it will be apparent to one of ordinary skill in the art that various changes in form and details may be made in these example embodiments without departing from the spirit and scope of the claims and their equivalents. The example embodiments described herein are to be considered in a descriptive sense only, and not for purposes of limitation. Descriptions of features or aspects in each example embodiment are to be considered as being applicable to similar features or aspects in other example embodiments. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A wearable device comprising:
a motor;
a motor driver circuit configured to control the motor;
a communication circuit configured to receive first movement information of a first user from a server or an electronic device;
a frame connected to the motor and worn on a body part of a second user;
a sensor; and
a processor configured to:
acquire second movement information of the second user using the sensor,
calculate a difference between the second movement information and the first movement information,
determine a torque intensity based on the difference, and
control the motor driver circuit to output a torque corresponding to the torque intensity through the motor.

2. The wearable device of claim 1, wherein based on the difference being greater than a reference value, the processor is further configured to:
identify a gain for increasing the torque intensity,
determine the torque intensity based on the gain and the difference,
determine a torque direction to be a first direction opposite to a second direction in which the body part of the second user moves,
control a converter to draw power corresponding to the torque intensity from a battery, and
turn on one or more switches, among a plurality of switches of the motor driver circuit and turn off remaining switches, among a plurality of switches, to control the motor to rotate in the torque direction to output the torque that resists a movement of the second user.

3. The wearable device of claim 1, wherein based on the difference being less than a reference value, the processor is further configured to:
identify a gain for increasing the torque intensity,
determine the torque intensity using the gain and the difference,
determine a torque direction to be a same direction as a direction in which the body part of the second user moves,
control a converter to draw power corresponding to the torque intensity from a battery, and
turn on one or more switches, among a plurality of switches of the motor driver circuit and turn off remaining switches, among a plurality of switches, to control the motor to rotate in the torque direction to output the torque that assists a movement of the second user.

4. The wearable device of claim 1, wherein the first movement information comprises a joint angle of the first user,
wherein the second movement information comprises a joint angle of the second user, and
wherein the first movement information of the first user is generated by sensing a movement of the first user in another wearable device worn by the first user located remotely.

5. The wearable device of claim 1, wherein the communication circuit is configured to receive the first movement information, which is extracted from a content comprising image data and audio data generated by capturing a movement of the first user in advance and movement information generated by sensing a movement of the first user in another wearable device worn by the first user.

6. The wearable device of claim 1, wherein the communication circuit is configured to transmit the second movement information of the second user to the electronic device.

7. The wearable device of claim 1, further comprising:
an inertial measurement unit (IMU) sensor configured to acquire at least one of acceleration information, angular velocity information, or posture information of the second user,
wherein the communication circuit is configured to transmit the at least one of the acceleration information, the angular velocity information, or the posture information to the electronic device.

8. A remote training system comprising:
a server;
a first wearable device configured to be worn on a first user; and
a second wearable device configured to be worn on a second user,
wherein the first wearable device is further configured to:
acquire first movement information of the first user, and
transmit the first movement information of the first user to the second wearable device through the server, and
wherein the second wearable device is further configured to:
receive the first movement information of the first user through the server,
acquire second movement information of the second user,
calculate a difference between the first movement information of the first user and the second movement information of the second user,
determine a torque intensity based on the difference, and
output a torque corresponding to the torque intensity to the second user.

9. The remote training system of claim 8, wherein based on the difference being greater than a reference value, the second wearable device is further configured to:
identify a gain for increasing the torque intensity,
determine the torque intensity based on the gain and the difference,
determine a torque direction to be a first direction opposite to a second direction in which the second user moves,
control a converter to draw power corresponding to the torque intensity from a battery, and
turn on one or more switches, among a plurality of switches of a motor driver circuit of the second wearable device and turn off remaining switches, among a plurality of switches, to control a motor of the second wearable device to rotate in the torque direction to output the torque that resists a movement of the second user.

10. The remote training system of claim 8, wherein based on the difference being less than a reference value, the second wearable device is further configured to:
identify a gain for increasing the torque intensity,
determine the torque intensity using the gain and the difference,
determine a torque direction to be a same direction as a direction in which the second user moves,
control a converter to draw power corresponding to the torque intensity from a battery, and
turn on one or more switches, among a plurality of switches of a motor driver circuit of the second wearable device and turn off remaining switches, among a plurality of switches, to control a motor of the second wearable device to rotate in the torque direction to output the torque that assists a movement of the second user.

11. The remote training system of claim 8, wherein the first movement information of the first user comprises a joint angle of the first user,
wherein the second movement information of the second user comprises a joint angle of the second user, and
wherein the first wearable device is configured to transmit the second movement information of the second user to the second wearable device through the server.

12. The remote training system of claim 8, wherein the second wearable device is connected to a first electronic device of the first user to receive the first movement information of the first user from the first electronic device of the first user, and
wherein the second user wearable device is connected to a second electronic device of the second user.

13. The remote training system of claim 12, wherein the first electronic device of the first user is configured to transmit image data and audio data generated by capturing a movement of the first user to the server and transmit the first movement information of the first user to the server,
wherein the server is configured to temporally synchronize the image data, the audio data, and the movement information of the first user received from the first electronic device of the first user and transmit the temporally synchronized image data, audio data, and movement information of the first user to the second electronic device of the second user, and
wherein the second electronic device of the second user is configured to output the image data and the audio data received from the server and transmit the first movement information of the first user to the second wearable device.

14. A streaming-based training system comprising:
a server configured to stream content comprising image data and audio data related to an exercise, and first movement information of a first user to an electronic device of a second user; and
a wearable device connected to the electronic device, the wearable device is configured to:
receive the first movement information of the first user from the electronic device,
acquire second movement information of the second user,
calculate a difference between the second movement and the first movement information,
determine a torque intensity based on the difference, and
output a torque corresponding to the torque intensity to the second user.

15. An operation method of a wearable device, the operation method comprising:
receiving first movement information of a first user from a server or an electronic device;
acquiring second movement information of the second user;
calculating a difference between the first movement information and the second movement information;
determining a torque intensity based on the difference; and
controlling a motor of the wearable device to output a torque corresponding to the torque intensity.
